(19) United States
(12) Patent Application Publication
(10) Pub. No.: US 2014/0320379 A1
(43) Pub. Date: Oct. 30, 2014

(54) ANTENNA APPARATUS CAPABLE OF REDUCING DECREASES IN GAIN AND BANDWIDTH

(71) Applicant: Panasonic Corporation, Osaka (JP)

(72) Inventor: Taichi HAMABE, Osaka (JP)

(21) Appl. No.: 14/330,371

(22) Filed: Jul. 14, 2014

Related U.S. Application Data
(63) Continuation of application No. PCT/JP2013/007445, filed on Dec. 18, 2013.

(30) Foreign Application Priority Data
Jan. 28, 2013 (JP) 2013-012835

(51) Int. Cl. H01Q 21/00

(52) U.S. Cl. CPC H01Q 21/0075
USPC 343/893

(57) ABSTRACT

An antenna apparatus is provided with an antenna and a ground conductor plate. The antenna is provided with: a dielectric substrate having a first surface and a second surface; a feed element having a strip shape and formed on the first surface of the dielectric substrate, the feed element having a first end connected to a feeding point, and an opened second end; and a parasitic element having a strip shape and formed on the second surface of the dielectric substrate, the parasitic element having a first end connected to the ground conductor plate, and an opened second end. The feed element and the parasitic element are arranged to oppose each other, at at least a portion including the second end of the feed element and the second end of the parasitic element.

### CROSS-REFERENCE TO RELATED APPLICATIONS

This is a continuation application of International Application No. PCT/JP2013/007445, with an international filing date of Dec. 18, 2013, which claims priority of Japanese Patent Application No. 2013-012835 filed on Jan. 28, 2013, the content of which is incorporated herein by reference.

### BACKGROUND

1. Technical Field

The present disclosure relates to an antenna apparatus, a wireless communication apparatus provided with the antenna apparatus, and an electronic apparatus provided with the wireless communication apparatus.

2. Description of Related Art

Electronic apparatuses have been widely used, each electronic apparatus being provided with a wireless communication apparatus for receiving broadcast signals of, e.g., terrestrial digital television broadcast, and a display apparatus for displaying contents of the received broadcast signals. Various shapes and arrangements for antennas of the wireless communication apparatuses are proposed (e.g., see Japanese Patent laid-open Publication No. 2007-281906 A).

### SUMMARY

In the case that an electronic apparatus provided with a wireless communication apparatus is configured as a mobile apparatus, an antenna of the wireless communication apparatus may be close to other metal components in the electronic apparatus, because of a limited size of a housing of the electronic apparatus. In this case, the gain of the antenna may decrease, since a current having a direction opposite to that of a current flowing in the antenna may flow in the metal components. In addition, the bandwidth of the antenna may decrease, due to a capacitance between the antenna and the metal components.

Further, in order to improve reception sensitivity, for example, an adaptive control may be performed, such as the combined diversity scheme, in which a plurality of antennas are provided inside or outside a housing of an electronic apparatus, and received signals received with the plurality of antennas are combined in phase. In this case, the problems of the decreases in the gain and in the bandwidth of the antennas may become more significant than those in the case of using one antenna.

One non-limiting and exemplary embodiment presents an antenna apparatus effective to reduce the decreases in the gain and in the bandwidth. In addition, the present disclosure presents a wireless communication apparatus provided with the antenna apparatus, and an electronic apparatus provided with the wireless communication apparatus.

An antenna apparatus of a general aspect of the present disclosure is provided with at least one antenna and a ground conductor plate. Each of the at least one antenna is provided with: a dielectric substrate having a first surface and a second surface; a first feed element having a strip shape and formed on the first surface of the dielectric substrate, the first feed element having a first end connected to a feeding point, and the first feed element having an opened second end; and a parasitic element having a strip shape and formed on the second surface of the dielectric substrate, the parasitic element having a first end connected to the ground conductor plate, and the parasitic element having an opened second end. The first feed element and the parasitic element are arranged to oppose each other, at at least a portion including the second end of the first feed element and the second end of the parasitic element.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

The antenna apparatus, the wireless communication apparatus, and the electronic apparatus of the present disclosure are effective to reduce the decreases in the gain and in the bandwidth of the antenna apparatus.

### BRIEF DESCRIPTION OF DRAWINGS

FIG. 1 is a perspective view showing an electronic apparatus 100 according to a first embodiment.

FIG. 2 is an exploded perspective view of the electronic apparatus 100 of FIG. 1.

FIG. 3 is a cross-sectional view of the electronic apparatus 100 at an A-A line of FIG. 1.

FIG. 4 is a plan view of an antenna apparatus 107 of FIG. 2, seen from a front side thereof.

FIG. 5 is a plan view of the antenna apparatus 107 of FIG. 2, seen from a back side thereof.

FIG. 6 is a radiation pattern diagram of a vertically-polarized radio wave of an antenna 1 of FIG. 2.

FIG. 7 is a radiation pattern diagram of a vertically-polarized radio wave of an antenna 2 of FIG. 2.

FIG. 8 is a radiation pattern diagram of a vertically-polarized radio wave of an antenna 3 of FIG. 2.

FIG. 9 is a radiation pattern diagram of a vertically-polarized radio wave of an antenna 4 of FIG. 2.

FIG. 10 is a radiation pattern diagram of a horizontally-polarized radio wave of the antenna 1 of FIG. 2.

FIG. 11 is a radiation pattern diagram of a horizontally-polarized radio wave of the antenna 2 of FIG. 2.

FIG. 12 is a radiation pattern diagram of a horizontally-polarized radio wave of the antenna 3 of FIG. 2.

FIG. 13 is a radiation pattern diagram of a horizontally-polarized radio wave of the antenna 4 of FIG. 2.

FIG. 14 is a graph showing average gain versus frequency characteristics for the antennas 1 to 4 of FIG. 2.

FIG. 15 is a plan view of an antenna apparatus 107A according to a second embodiment, seen from a front side thereof.

FIG. 16 is a plan view of the antenna apparatus 107A of FIG. 15, seen from a back side thereof.

FIG. 17 is an enlarged view of an antenna 1A of FIG. 15.

FIG. 18 is a plan view of an antenna apparatus 107B according to a modified embodiment of the second embodiment, seen from a back side thereof.

FIG. 19 is a graph showing average gain versus frequency characteristics for the antennas 1A, 2A, 3A, and 4 of FIGS. 15 and 16.

### DETAILED DESCRIPTION

Embodiments are described in detail below with appropriate reference to the drawings. It is noted that excessively detailed explanation may be omitted. For example, detailed explanation on the already well-known matter, and repeated explanations on substantially the same configurations may be omitted. It is intended to avoid excessive redundancy of the following explanation and facilitate understanding of those skilled in the art.

The applicant provides accompanying drawings and the following explanation in order for those skilled in the art to fully understand the present disclosure, and does not intend to limit claimed subject matters by the drawings and explanation.

### 1. First Embodiment

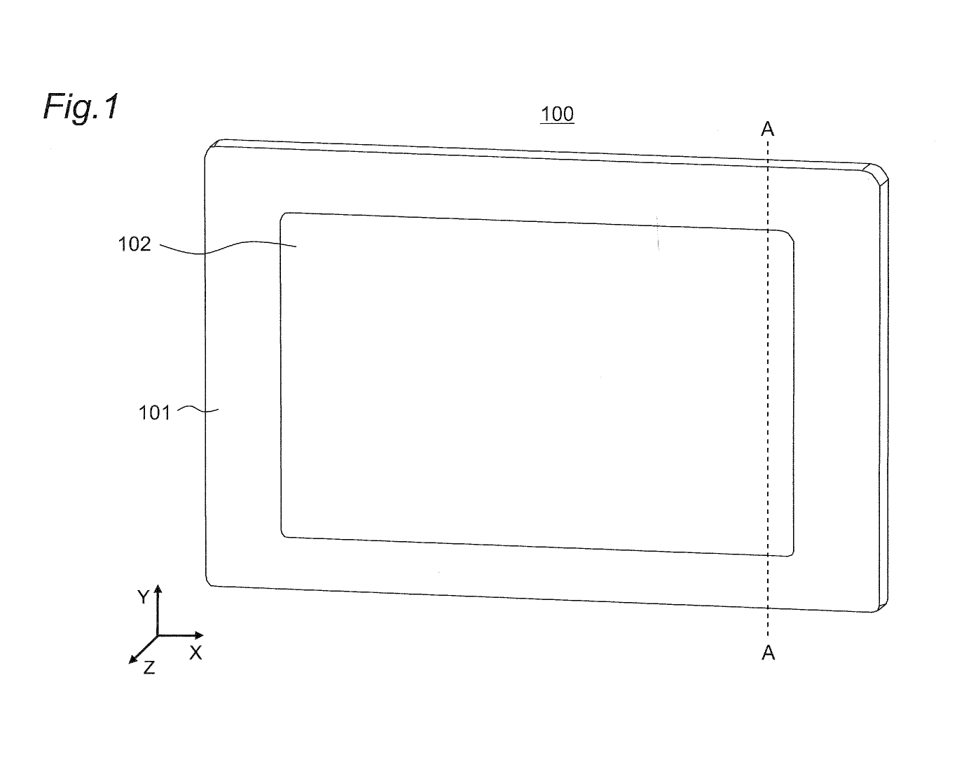

Hereinafter, a first embodiment is described with reference to FIGS. 1 to 14.

[1-1. Configuration]

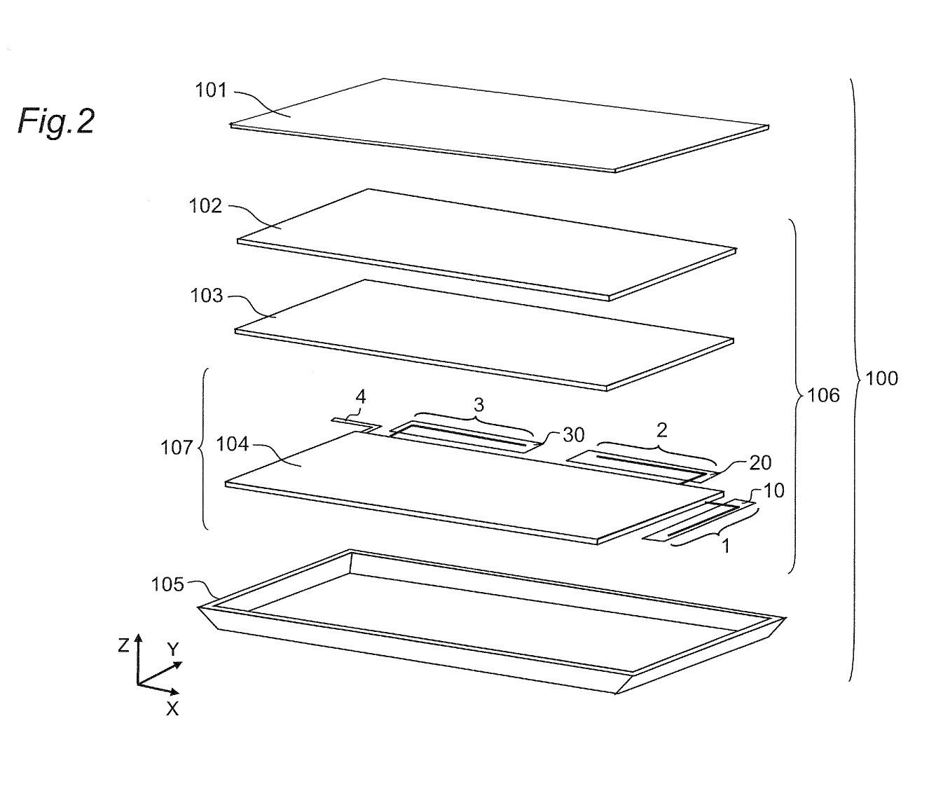

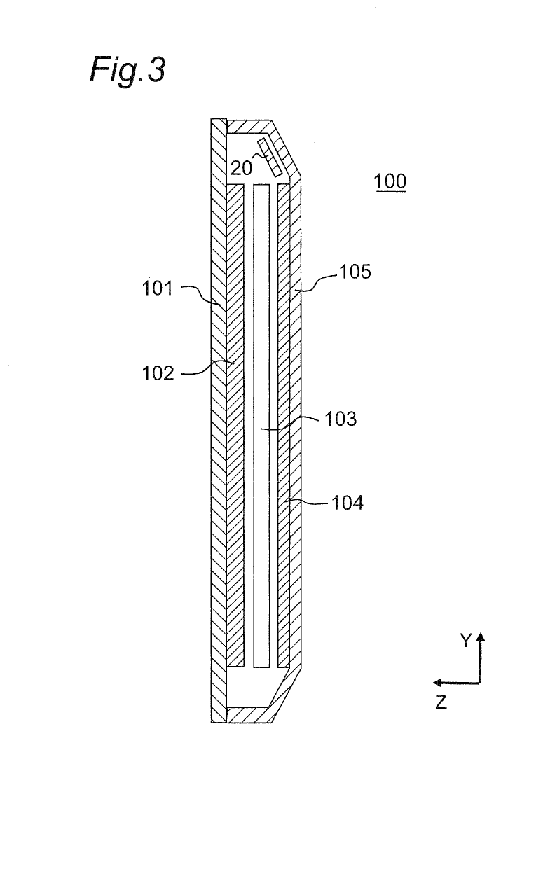

FIG. 1 is a perspective view showing an electronic apparatus 100 according to a first embodiment. FIG. 2 is an exploded perspective view of the electronic apparatus 100 of FIG. 1. FIG. 3 is a cross-sectional view of the electronic apparatus 100 at an A-A line of FIG. 1. In the drawings, the XYZ coordinate shown in each drawing is referred to. With respect to FIG. 1, etc., the +Z side of the electronic apparatus 100 is called as “front”, and the −Z side of the electronic apparatus 100 is called as “back”. In addition, λ denotes a wavelength corresponding to a frequency “f” within an operating band of the electronic apparatus 100.

As shown in FIGS. 1 to 3, the electronic apparatus 100 is configured by installing a television receiving apparatus 106 within an outer housing, the outer housing including a front panel 101 and a back cover 105. The television receiving apparatus 106 includes a liquid crystal display (LCD) 102, a main circuit board 103, and an antenna apparatus 107. The antenna apparatus 107 is provided with: antennas 1 to 4 formed on dielectric substrates 10, 20, and 30, respectively; and a ground conductor plate 104. The ground conductor plate 104 is, e.g., a planar conductor component of the electronic apparatus 100. The ground conductor plate 104 has a size equivalent to, e.g., that of the liquid crystal display 102, and, e.g., has a rectangular shape with a length in X direction of λ/2, and a length in Y direction of λ/4. The ground conductor plate 104 is arranged, e.g., in a position close to and parallel to the liquid crystal display 102.

The back cover 105 may be configured by chamfering edges of +X, −X, +Y, and −Y sides on the back (see FIGS. 2 and 3). In this case, the dielectric substrates 10, 20, and 30 may be located at the chamfered portions of the back cover 105. As shown in FIG. 2, for example, the dielectric substrate 10 may be located at the chamfered portion of +X side of the back cover 105, and the dielectric substrates 20 and 30 may be located at the chamfered portion of +Y side of the back cover 105.

The electronic apparatus 100 of FIG. 1 is, e.g., a mobile apparatus for receiving broadcast signals of the frequency band of the terrestrial digital television broadcast (473 MHz to 767 MHz), and displaying their contents.

The main circuit board 103 includes a circuit for controlling operation of the entire electronic apparatus 100. In particular, the main circuit board 103 is, e.g., a printed circuit board, and provided with: a power supply circuit for supplying a power supply voltage to respective circuits on the main circuit board 103; a wireless receiving circuit (tuner); and an LCD driving circuit. The wireless receiving circuit is connected to antennas 1 to 4, respectively. The wireless receiving circuit processes four received signals received by the antennas 1 to 4, using the polarization diversity (i.e., weights the respective received signals according to the signal-to-noise ratio), and combines the four received signals to one received signal. The wireless receiving circuit outputs video signals and audio signals contained in the combined received signal. In addition, the LCD driving circuit performs certain image processing on the video signals from the wireless receiving circuit, and drives the liquid crystal display 102 to display an image. Further, the electronic apparatus 100 is provided with components, such as, voice processing circuit for performing certain processing on the audio signals from the wireless receiving circuit, a speaker for outputting the processed audio signals, a recorder apparatus and a player apparatus for the video signals and the audio signals, and a metal member for radiation to reduce heat generated from components, such as the main circuit board 103 (not shown).

The antenna apparatus 107 provided with the antennas 1 to 4, and the wireless receiving circuit on the main circuit board 103 make up a wireless communication apparatus which receives the radio signals.

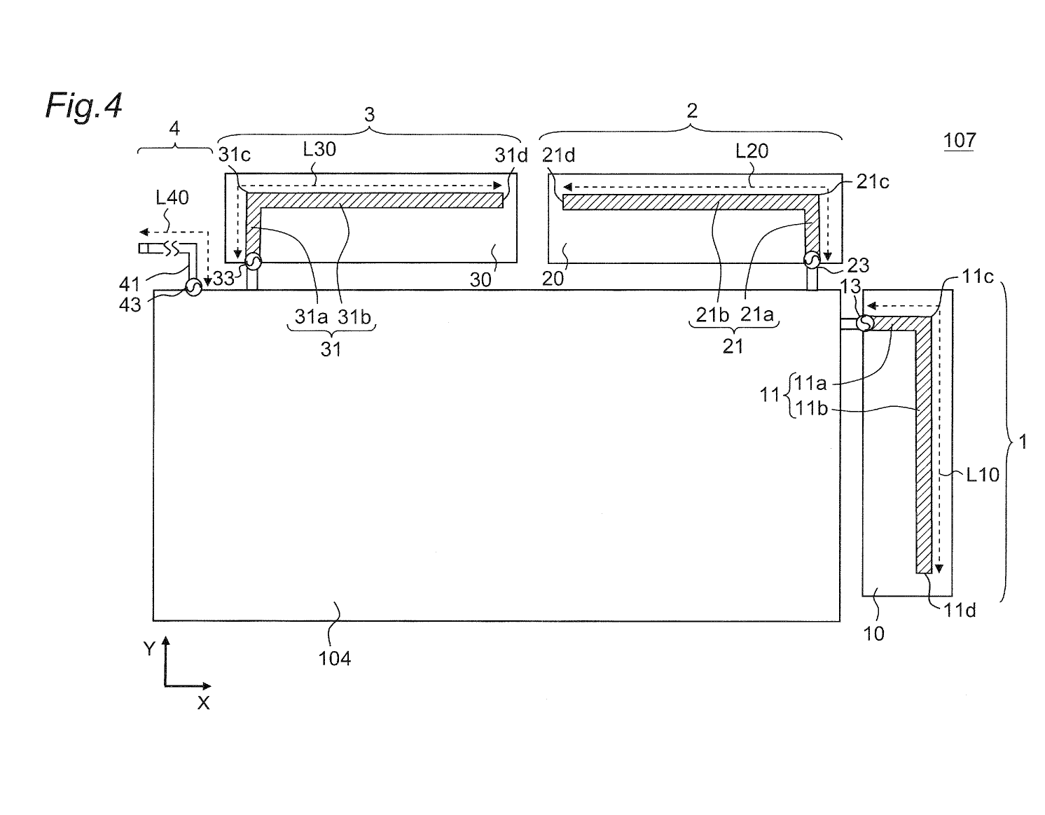

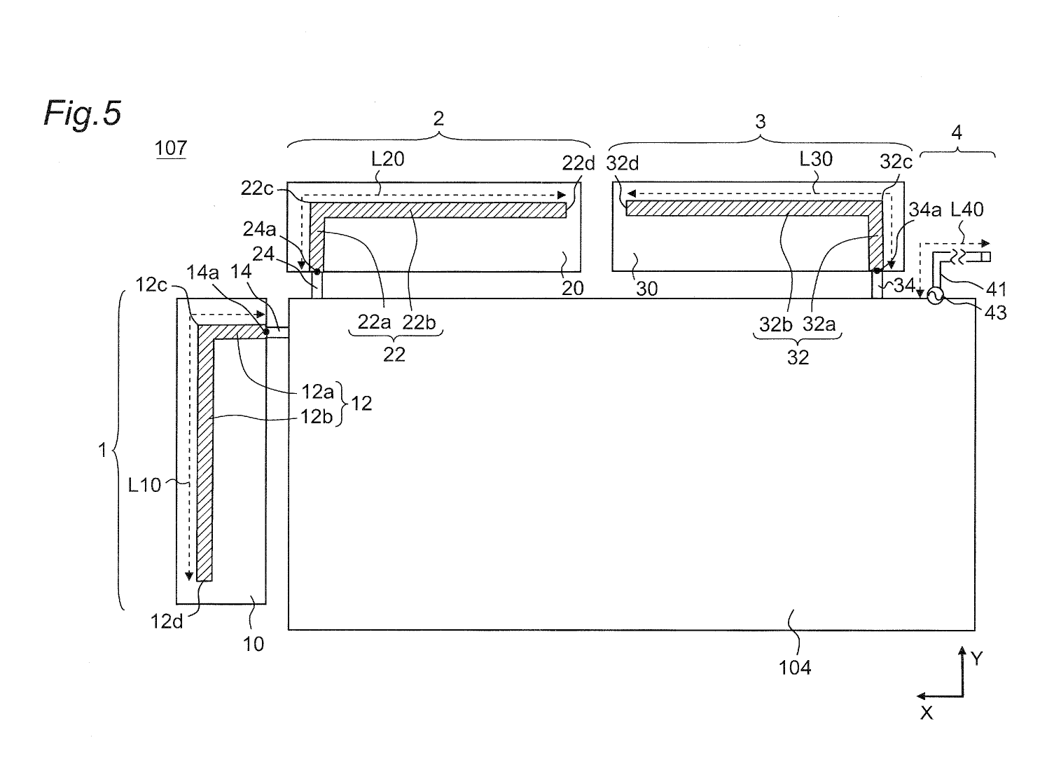

FIG. 4 is a plan view of the antenna apparatus 107 of FIG. 2, seen from a front side thereof. FIG. 5 is a plan view of the antenna apparatus 107 of FIG. 2, seen from a back side thereof. The front side of the antenna apparatus 107 opposes the main circuit board 103, and the back side of the antenna apparatus 107 opposes the back cover 105.

First, the antenna 1 is explained.

The antenna 1 is provided with: a dielectric substrate 10, a feed element 11 having a strip shape and formed on the front side of the dielectric substrate 10 (FIG. 4), and a parasitic element 12 having a strip shape and formed on the back side of the dielectric substrate 10 (FIG. 5). The feed element 11 and the parasitic element 12 are made of conductive foil, such as copper or silver. The dielectric substrate 10, the feed element 11, and the parasitic element 12 are configured as, e.g., a printed-circuit board having conductor layers on both sides.

As shown in FIGS. 4 and 5, the feed element 11 and the parasitic element 12 may be formed to be of, e.g., an inverted-L type. Referring to FIG. 4, the feed element 11 includes element parts 11a and 11b, which are connected to each other at a connecting point 11c. The element part 11a extends substantially toward the +X direction from a position close to the ground conductor plate 104. The element part 11a is connected to a feeding point 13 at one end of the element part 11a, and connected to the element part 11b at the connecting point 11c of the other end of the element part 11a. The element part 11b extends substantially toward the −Y direction from the connecting point 11c. The element part 11b is opened at an open end 11d of one end of the element part 11b, and connected to the element part 11a at the connecting point 11c of the other end of the element part 11b. Referring to FIG. 5, the parasitic element 12 includes element parts 12a and 12b, which are connected to each other at a connecting point 12c. The element part 12a extends substantially toward the +X direction from a position close to the ground conductor plate 104. The element part 12a is connected to a connecting conductor 14 at a connecting point 14a located at one end of the element part 12a, and grounded to an edge of the ground conductor plate 104 through the connecting conductor 14. The element part 12a is connected to the element part 12b at the connecting point 12c of the other end of the element part 12a. The element part 12b extends substantially toward the −Y direction from the connecting point 12c. The element part 12b is opened at an open end 12d of one end of the element part 12b, and connected to the element part 12a at the connecting point 12c of the other end of the element part 12b.

As described above, the feed element 11 has the end connected to the feeding point 13 (first end), and the open end 11d (second end). The parasitic element 12 has the end connected to the ground conductor plate 104 (first end), and the open end 12d (second end). The feed element 11 and the parasitic element 12 are arranged to oppose each other, at at least a portion including the open end 11d of the feed element 11 and the open end 12d of the parasitic element 12.

The feed element 11 and the parasitic element 12 may be arranged to be capacitively coupled to each other, at at least a portion including the open end 11d of the feed element 11 and the open end 12d of the parasitic element 12. In this case, since the open end 11d of the feed element 11 and the open end 12d of the parasitic element 12 are capacitively coupled to each other, the antenna 1 operates as a folded antenna including the feed element 11 and the parasitic element 12, and being folded at the open ends 11d and 12d. An electric length L10 of each of the feed element 11 and the parasitic element 12 capacitively coupled to each other is set to λ/4, and therefore, an electric length of the folded antenna is set to λ/2, and the folded antenna resonates at the frequency f. Thus, the feed element 11 and the parasitic element 12 resonate at the frequency f corresponding to the wavelength λ determined by the sum of the electric length L10 of the feed element 11 and the electric length L10 of the parasitic element 12.

The feed element 11 and the parasitic element 12 may be arranged to overlap each other, at at least a portion including the open end 11d of the feed element 11 and the open end 12d of the parasitic element 12.

Now, the antenna 2 is explained.

The antenna 2 is provided with: a dielectric substrate 20, a feed element 21 having a strip shape and formed on the front side of the dielectric substrate 20 (FIG. 4), and a parasitic element 22 having a strip shape and formed on the back side of the dielectric substrate 20 (FIG. 5). The feed element 21 and the parasitic element 22 are made of conductive foil, such as copper or silver. The dielectric substrate 20, the feed element 21, and the parasitic element 22 are configured as, e.g., a printed-circuit board having conductor layers on both sides.

As shown in FIGS. 4 and 5, the feed element 21 and the parasitic element 22 may be formed to be of, e.g., an inverted-L type. Referring to FIG. 4, the feed element 21 includes element parts 21a and 21b, which are connected to each other at a connecting point 21c. The element part 21a extends substantially toward the +Y direction from a position close to the ground conductor plate 104. The element part 21a is connected to a feeding point 23 at one end of the element part 21a, and connected to the element part 21b at the connecting point 21c of the other end of the element part 21a. The element part 21b extends substantially toward the −X direction from the connecting point 21c.

The element part 21b is opened at an open end 21d of one end of the element part 21b, and connected to the element part 21a at the connecting point 21c of the other end of the element part 21b. Referring to FIG. 5, the parasitic element 22 includes element parts 22a and 22b, which are connected to each other at a connecting point 22c. The element part 22a extends substantially toward the +Y direction from a position close to the ground conductor plate 104. The element part 12a is connected to a connecting conductor 24 at a connecting point 24a located at one end of the element part 22a, and grounded to an edge of the ground conductor plate 104 through the connecting conductor 24. The element part 22a is connected to the element part 22b at the connecting point 22c of the other end of the element part 22a. The element part 22b extends substantially toward the −X direction from the connecting point 22c. The element part 22b is opened at an open end 22d of one end of the element part 22b, and connected to the element part 22a at the connecting point 22c of the other end of the element part 22b.

As described above, the feed element 21 has the end connected to the feeding point 23 (first end), and the open end 21d (second end). The parasitic element 22 has the end connected to the ground conductor plate 104 (first end), and the open end 22d (second end). The feed element 21 and the parasitic element 22 are arranged to oppose each other, at at least a portion including the open end 21d of the feed element 21 and the open end 22d of the parasitic element 22.

The feed element 21 and the parasitic element 22 may be arranged to be capacitively coupled to each other, at at least a portion including the open end 21d of the feed element 21 and the open end 22d of the parasitic element 22. In this case, since the open end 21d of the feed element 21 and the open end 22d of the parasitic element 22 are capacitively coupled to each other, the antenna 2 operates as a folded antenna including the feed element 21 and the parasitic element 22, and being folded at the open ends 21d and 22d. An electric length L20 of each of the feed element 21 and the parasitic element 22 capacitively coupled to each other is set to λ/4, and therefore, an electric length of the folded antenna is set to λ/2, and the folded antenna resonates at the frequency f. Thus, the feed element 21 and the parasitic element 22 resonate at the frequency f corresponding to the wavelength λ determined by the sum of the electric length L20 of the feed element 21 and the electric length L20 of the parasitic element 22.

The feed element 21 and the parasitic element 22 may be arranged to overlap each other, at at least a portion including the open end 21d of the feed element 21 and the open end 22d of the parasitic element 22.

Now, the antenna 3 is explained.

The antenna 3 is provided with: a dielectric substrate 30, a feed element 31 having a strip shape and formed on the front side of the dielectric substrate 30 (FIG. 4), and a parasitic element 32 having a strip shape and formed on the back side of the dielectric substrate 30 (FIG. 5). The feed element 31 and the parasitic element 32 are made of conductive foil, such as copper or silver. The dielectric substrate 30, the feed element 31, and the parasitic element 32 are configured as, e.g., a printed-circuit board having conductor layers on both sides.

As shown in FIGS. 4 and 5, the feed element 31 and the parasitic element 32 may be to be of, e.g., an inverted-L type. Referring to FIG. 4, the feed element 31 includes element parts 31a and 31b, which are connected to each other at a connecting point 31c. The element part 31a extends substantially toward the +Y direction from a position close to the ground conductor plate 104.

The element part 31a is connected to a feeding point 33 at one end of the element part 31a, and connected to the element part 31b at the connecting point 31c of the other end of the element part 31a. The element part 31b extends substantially toward the +X direction from the connecting point 31c. The element part 31b is opened at an open end 31d of one end of the element part 31b, and connected to the element part 31a at the connecting point 31c of the other end of the element part 31b. Referring to FIG. 5, the parasitic element 32 includes element parts 32a and 32b, which are connected to each other at a connecting point 32c. The element part 32a extends substantially toward the +Y direction from a position close to the ground conductor plate 104. The element part 32a is connected to a connecting conductor 34 at a connecting point 34a located at one end of the element part 32a, and grounded to an edge of the ground conductor plate 104 through the connecting conductor 34. The element part 32a is connected to the element part 32b at the connecting point 32c of the other end of the element part 32a. The element part 32b extends substantially toward the +X direction from the connecting point 32c. The element part 32b is opened at an open end 32d of one end of the element part 32b, and connected to the element part 32a at the connecting point 32c of the other end of the element part 32b.

As described above, the feed element 31 has the end connected to the feeding point 33 (first end), and the open end 31d (second end). The parasitic element 32 has the end connected to the ground conductor plate 104 (first end), and the open end 32d (second end). The feed element 31 and the parasitic element 32 are arranged to oppose each other, at at least a portion including the open end 31d of the feed element 31 and the open end 32d of the parasitic element 32.

The feed element 31 and the parasitic element 32 may be arranged to be capacitively coupled to each other, at at least a portion including the open end 31d of the feed element 31 and the open end 32d of the parasitic element 32. In this case, since the open end 31d of the feed element 31 and the open end 32d of the parasitic element 32 are capacitively coupled to each other, the antenna 3 operates as a folded antenna including the feed element 31 and the parasitic element 32, and being folded at the open ends 31d and 32d. An electric length L30 of each of the feed element 31 and the parasitic element 32 capacitively coupled to each other is set to λ/4, and therefore, an electric length of the folded antenna is set to λ/2, and the folded antenna resonates at the frequency f. Thus, the feed element 31 and the parasitic element 32 resonate at the frequency f corresponding to the wavelength λ determined by the sum of the electric length L30 of the feed element 31 and the electric length L30 of the parasitic element 32.

The feed element 31 and the parasitic element 32 may be arranged to overlap each other, at at least a portion including the open end 31d of the feed element 31 and the open end 32d of the parasitic element 32.

Now, the antenna 4 is explained.

Referring to FIGS. 4 and 5, the antenna 4 is a monopole antenna provided with a feed element 41 having a strip shape, and the antenna 4 is connected to a feeding point 43. The feed element 41 may be projected from the housing of the electronic apparatus 100 in the −X direction or any other direction. The electric length L40 of the feed element 41 is set to λ/4, and the antenna 4 resonates at the frequency f.

As described above, the antenna apparatus 107 is provided with the feeding points 13, 23, 33, and 43, and the antennas 1 to 4 connected to the respective feeding points. The antennas 1 to 4 are respectively connected to the wireless receiving circuit of the main circuit board 103 through feed lines each having an impedance of, e.g., 50 ohms. The wireless receiving circuit receives radio signals having the frequency f using the antennas 1 to 4.

At least one of the antennas 1 to 4 may have a different polarization direction from the other antennas. Therefore, for example, the antennas 1 to 4 are arranged as follows. The antenna 1 is provided close to an edge on the +X side of the ground conductor plate 104, and the feeding point 13 is provided close to a corner at the +X side and +Y side of the ground conductor plate 104. The antenna 2 is provided close to an edge on the +Y side of the ground conductor plate 104, and the feeding point 23 is provided close to the corner at the +X side and +Y side of the ground conductor plate 104. The antenna 3 is provided close to the edge on the +Y side of the ground conductor plate 104, and the feeding point 33 is provided close to a corner at the −X side and +Y side of the ground conductor plate 104. The antenna 4 is provided close to the corner at the −X side and the +Y side of the ground conductor plate 104, and the feeding point 43 is provided close to the corner at the −X side and the +Y side of the ground conductor plate 104. The antenna 1 receives a vertically-polarized radio wave having a polarization direction parallel to the X axis. The antenna 2 receives a vertically-polarized radio wave having a polarization direction parallel to the Y axis. The antenna 3 receives a vertically-polarized radio wave having a polarization direction parallel to the Y axis. The antenna 4 receives a horizontally-polarized radio wave.

For performing the polarization diversity processing, the antennas 1 to 4 are configured to have the same resonance frequency with each other. The antennas 1 to 3 may have different sizes from each other, in order to obtain the same resonance frequency, taking into consideration the influences from other components of the electronic apparatus 100.

[1-2. Operation]

Now, an operation of the antenna apparatus 107 configured as mentioned above is explained.

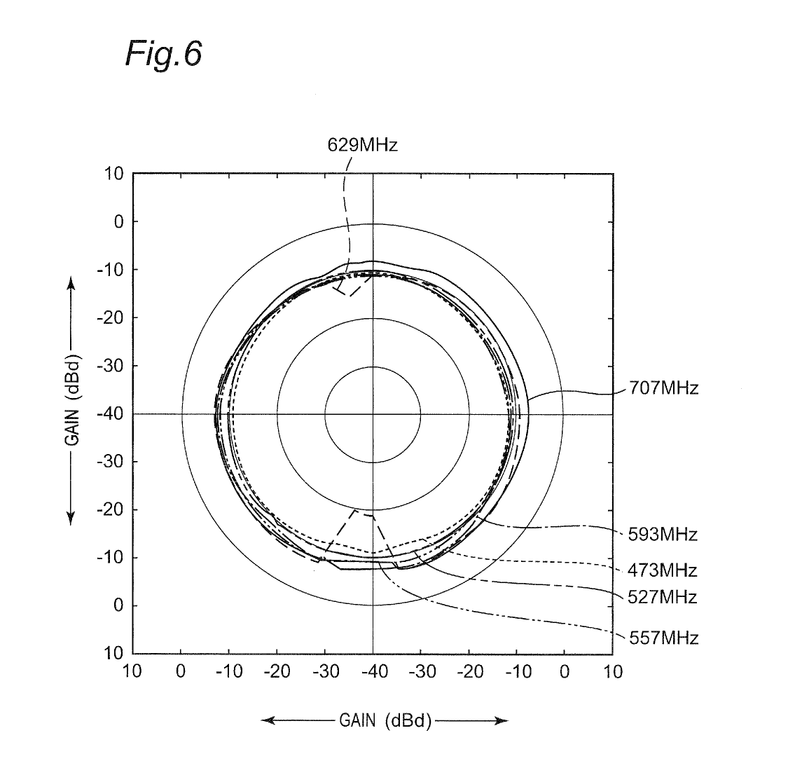

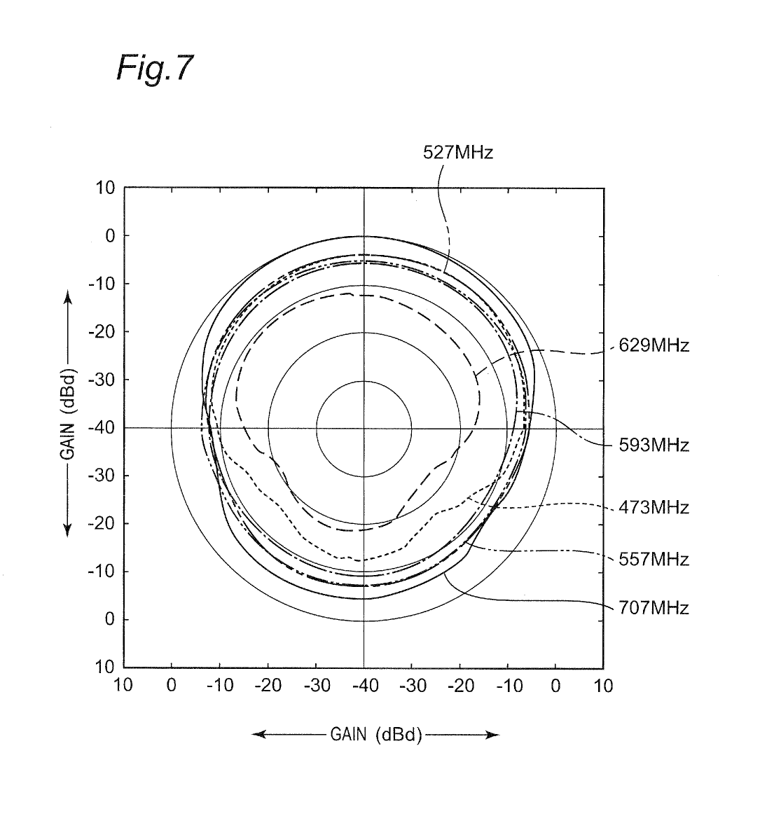

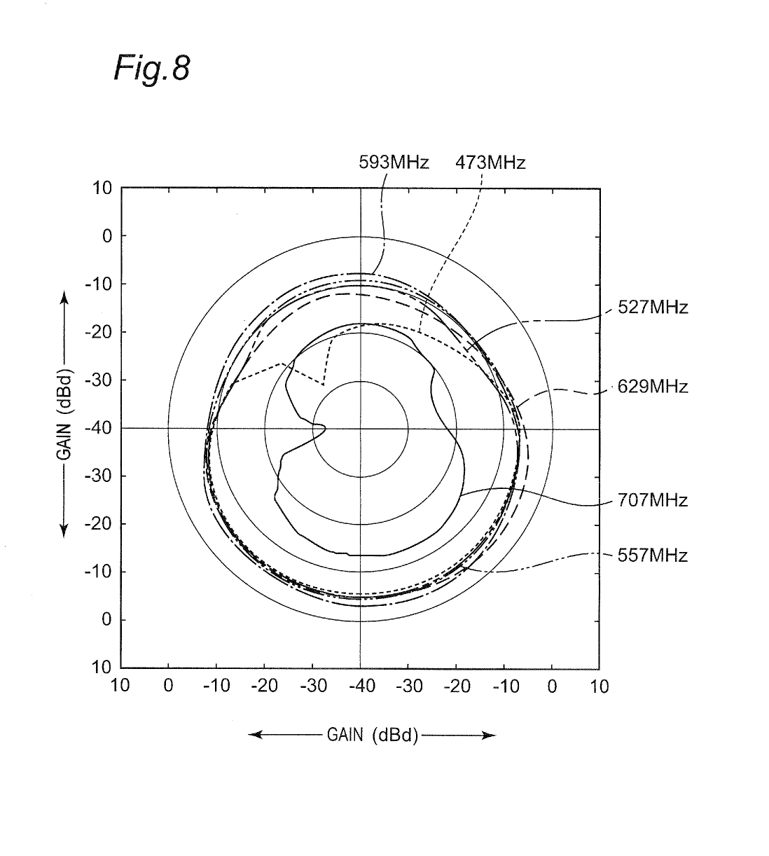

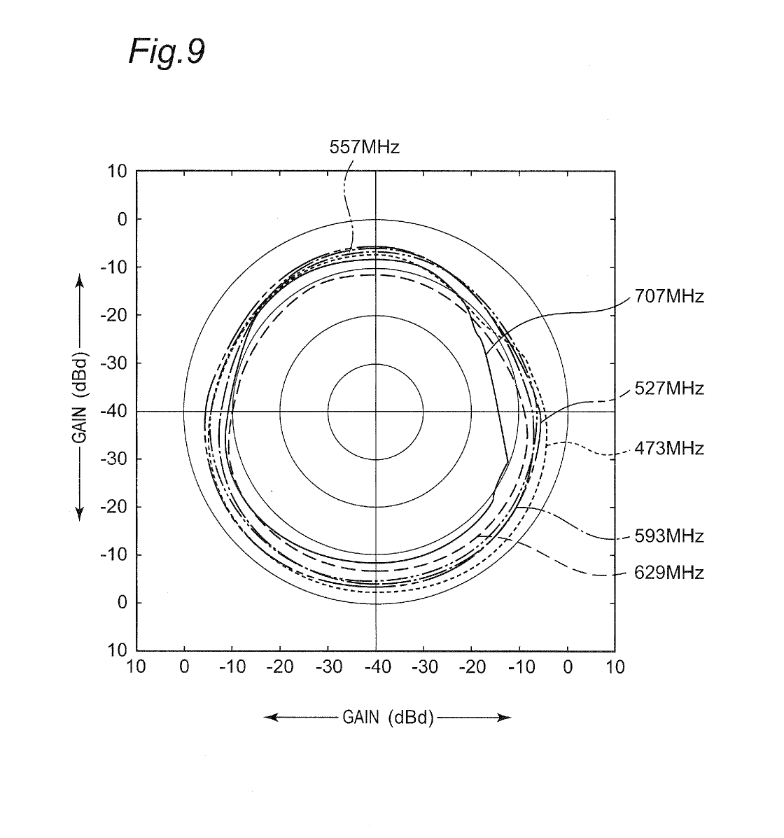

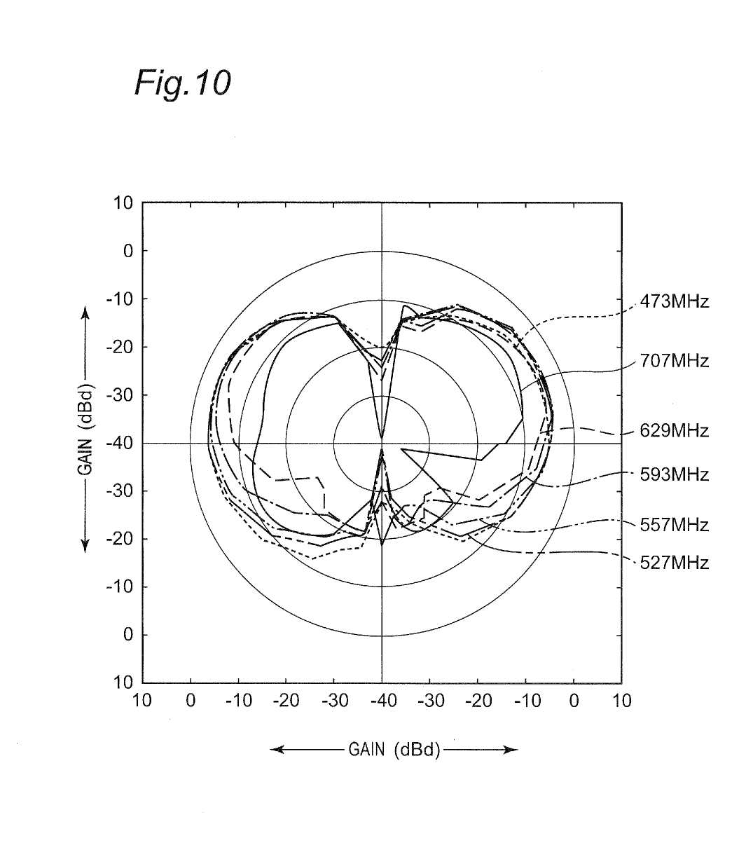

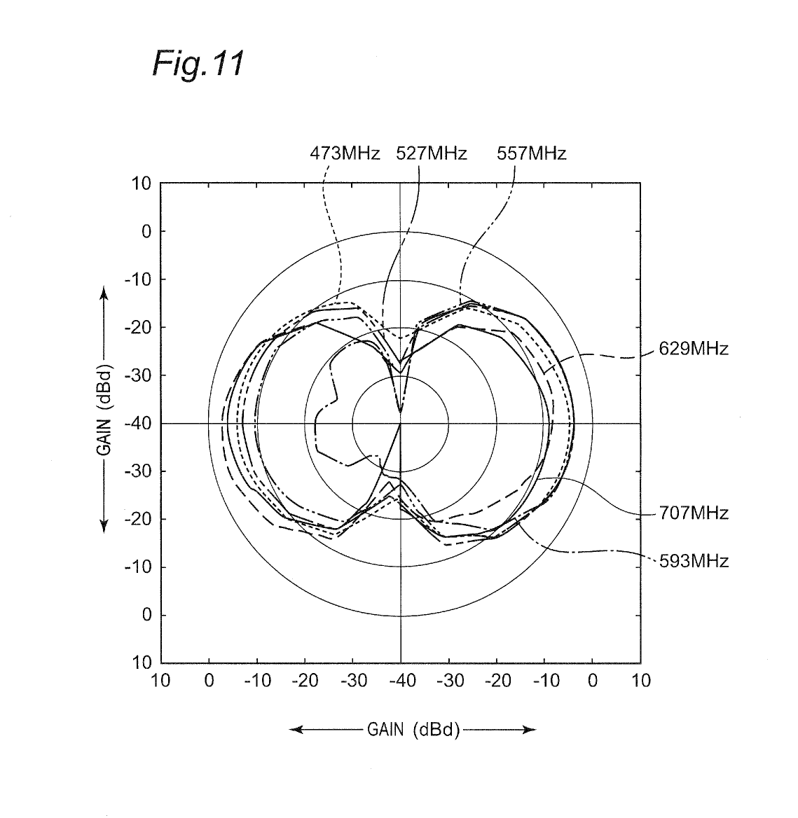

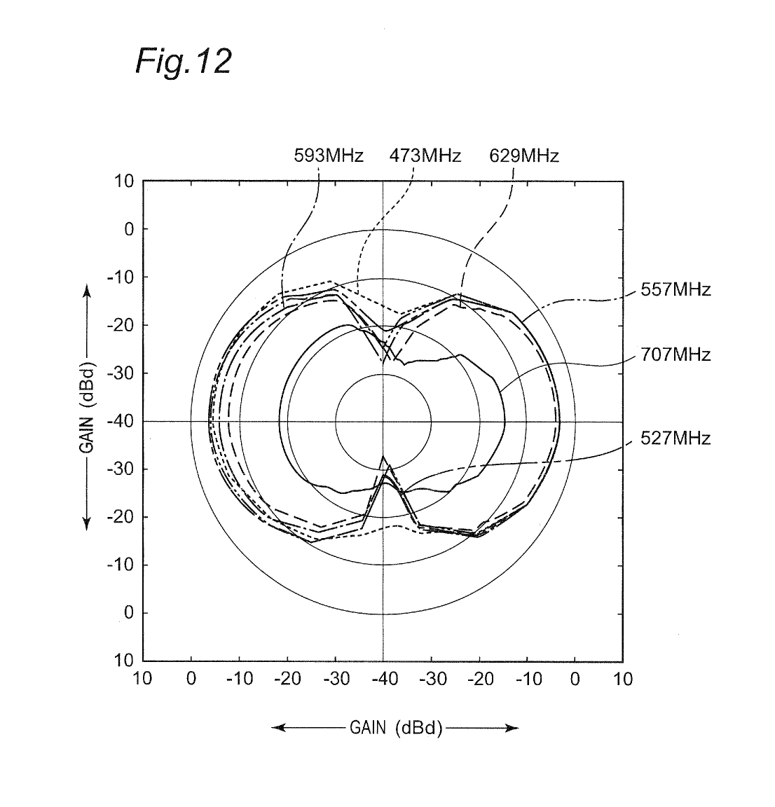

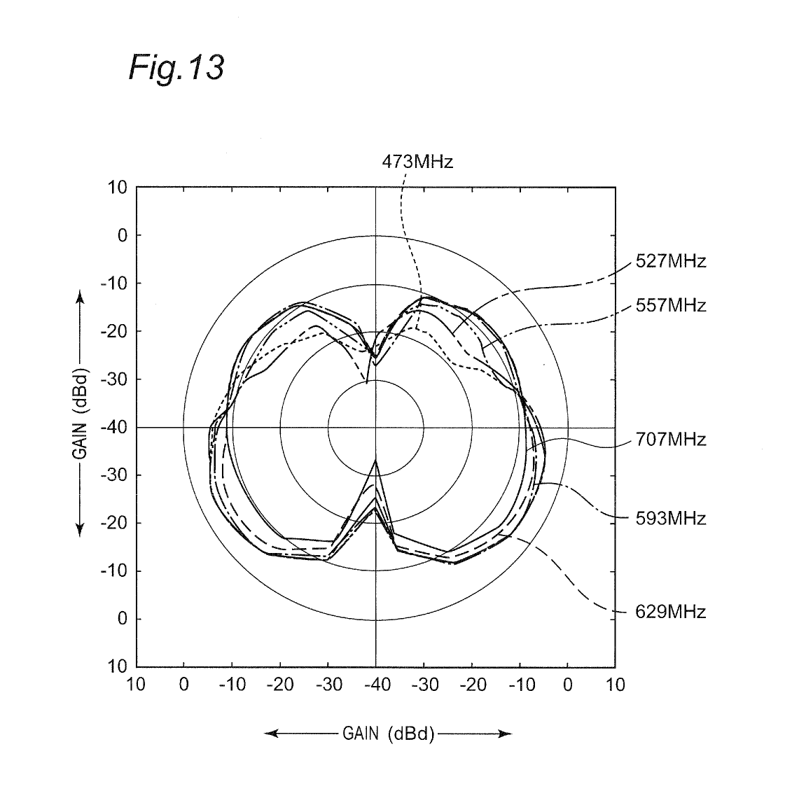

FIG. 6 is a radiation pattern diagram of a vertically-polarized radio wave of the antenna 1 of FIG. 2. FIG. 7 is a radiation pattern diagram of a vertically-polarized radio wave of the antenna 2 of FIG. 2. FIG. 8 is a radiation pattern diagram of a vertically-polarized radio wave of the antenna 3 of FIG. 2. FIG. 9 is a radiation pattern diagram of a vertically-polarized radio wave of the antenna 4 of FIG. 2. FIG. 10 is a radiation pattern diagram of a horizontally-polarized radio wave of the antenna 1 of FIG. 2. FIG. 11 is a radiation pattern diagram of a horizontally-polarized radio wave of the antenna 2 of FIG. 2. FIG. 12 is a radiation pattern diagram of a horizontally-polarized radio wave of the antenna 3 of FIG. 2. FIG. 13 is a radiation pattern diagram of a horizontally-polarized radio wave of the antenna 4 of FIG. 2. As shown in FIGS. 6 to 9, the antennas 1 to 4 are substantially omnidirectional for vertically-polarized radio waves over the entire frequency band of the terrestrial digital television broadcast.

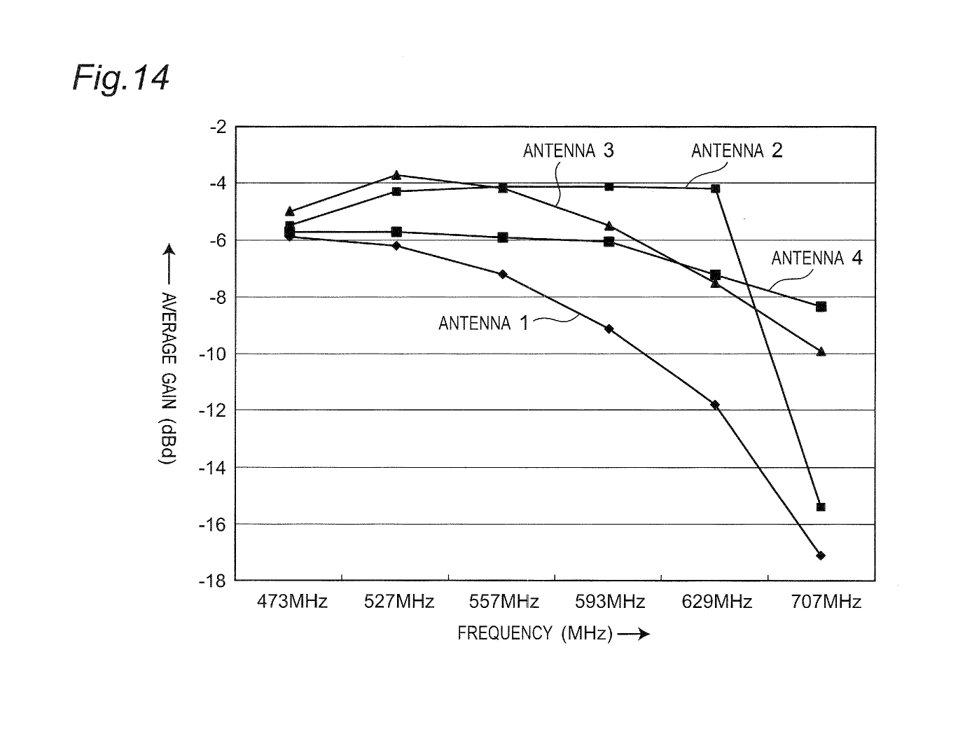

FIG. 14 is a graph showing average gain versus frequency characteristics for the antennas 1 to 4 of FIG. 2. The vertical axis of the graph shows an average gain under a cross polarization of −6 dB (“a gain of horizontal polarization”+(“a gain of vertical polarization”−6)). As shown in FIG. 14, an average of the average gains of the antennas 1 to 4 was −7.9 dBd or more at respective frequencies of the terrestrial digital television broadcast.

[1-3. Advantageous Effects, etc.]

As described above, the antenna apparatus 107 of the embodiment is provided with the antennas 1 to 4 and the ground conductor plate 104, and the antennas 1 to 3 are configured as follows.

The antenna 1 is provided with: the dielectric substrate 10, the feed element 11 having the strip shape and formed on the front side of the dielectric substrate 10, and the parasitic element 12 having the strip shape and formed on the back side of the dielectric substrate 10. The feed element 11 has the end connected to the feeding point 13 (first end), and the open end 11d (second end). The parasitic element 12 has the end connected to the ground conductor plate 104 (first end), and the open end 12d (second end). The feed element 11 and the parasitic element 12 are arranged to oppose each other, at at least a portion including the open end 11d of the feed element 11 and the open end 12d of the parasitic element 12. The feed element 11 and the parasitic element 12 may be arranged to be capacitively coupled to each other, at at least a portion including the open end 11d of the feed element 11 and the open end 12d of the parasitic element 12. In this case, the feed element 11 and the parasitic element 12 resonate at the frequency f corresponding to the wavelength λ determined by the sum of the electric length L10 of the feed element 11 and the electric length L10 of the parasitic element 12.

The antenna 2 is provided with: the dielectric substrate 20, the feed element 21 having the strip shape and formed on the front side of the dielectric substrate 20, and the parasitic element 22 having the strip shape and formed on the back side of the dielectric substrate 20. The feed element 21 has the end connected to the feeding point 23 (first end), and the open end 21d (second end). The parasitic element 22 has the end connected to the ground conductor plate 104 (first end), and the open end 22d (second end). The feed element 21 and the parasitic element 22 are arranged to oppose each other, at at least a portion including the open end 21d of the feed element 21 and the open end 22d of the parasitic element 22. The feed element 21 and the parasitic element 22 may be arranged to be capacitively coupled to each other, at at least a portion including the open end 21d of the feed element 21 and the open end 22d of the parasitic element 22. In this case, the feed element 21 and the parasitic element 22 resonate at the frequency f corresponding to the wavelength λ determined by the sum of the electric length L20 of the feed element 21 and the electric length L20 of the parasitic element 22.

The antenna 3 is provided with: the dielectric substrate 30, the feed element 31 having the strip shape and formed on the front side of the dielectric substrate 30, and the parasitic element 32 having the strip shape and formed on the back side of the dielectric substrate 30. The feed element 31 has the end connected to the feeding point 33 (first end), and the open end 31d (second end). The parasitic element 32 has the end connected to the ground conductor plate 104 (first end), and the open end 32d (second end). The feed element 31 and the parasitic element 32 are arranged to oppose each other, at at least a portion including the open end 31d of the feed element 31 and the open end 32d of the parasitic element 32. The feed element 31 and the parasitic element 32 may be arranged to be capacitively coupled to each other, at at least a portion including the open end 31d of the feed element 31 and the open end 32d of the parasitic element 32. In this case, the feed element 31 and the parasitic element 32 resonate at the frequency f corresponding to the wavelength λ determined by the sum of the electric length L30 of the feed element 31 and the electric length L30 of the parasitic element 32.

Thus, the antennas 1 to 3 can achieve wide band operation by using capacitive coupling between the feed elements and the parasitic elements, and using resonance of the ground conductor plate 104 due to the current flowing in the ground conductor plate 104. It is possible to reduce the decreases in the gain and in the bandwidth by using the antennas 1 to 3, as the inverted-L folded antennas each using the parallel resonance between a feed element and a parasitic element.

In addition, when the antennas 1 and 2 are provided adjacent to each other as shown in FIGS. 4 and 5, the antenna 1 receives a horizontally-polarized radio wave, and the antenna 2 receives a vertically-polarized radio wave. Therefore, the direction of a ground current resulting from the receiving operation of the antenna 1 is perpendicular to the direction of a ground current resulting from the receiving operation of the antenna 2. As a result, it is possible to increase the isolation between the antennas 1 and 2, and therefore, substantially prevent the decrease in the gain.

In addition, a distance between the feeding point 23 of the antenna 2 and the feeding point 33 of the antenna 3 is set to λ/4 or more. Therefore, when a ground current resulting from the receiving operation of the antenna 2 is flowing, no ground current resulting from the receiving operation of the antenna 3 flows. As a result, it is possible to increase the isolation between the antennas 2 and 3, and therefore, substantially prevent the decrease in the gain.

In addition, the antenna 3 receives a vertically-polarized radio wave, and the antenna 4 receives a horizontally-polarized radio wave. Therefore, it is possible to increase the isolation between the antennas 3 and 4, as compared with that of case where the antennas 3 and 4 receive radio waves having the same polarization direction, and therefore, it is possible to substantially prevent the decrease in the gain.

In addition, according to the antenna apparatus of the first embodiment, it is possible to reduce the size of the electronic apparatus 100, since the antennas 1 to 4 can be provided close to the ground conductor plate 104. In addition, it is possible to provide the electronic apparatus 100 which is inexpensive and highly water-resistant, since no housing is needed other than the housing of the electronic apparatus 100 itself to install the antenna apparatus provided with the antennas 1 to 4. In addition, since the antennas 1 to 3 can be arranged at the chamfered portions of the back cover 105, it is possible to emphasize the thinness in the appearance of the electronic apparatus 100, and strengthen the structure of its housing.

### 2. Second Embodiment

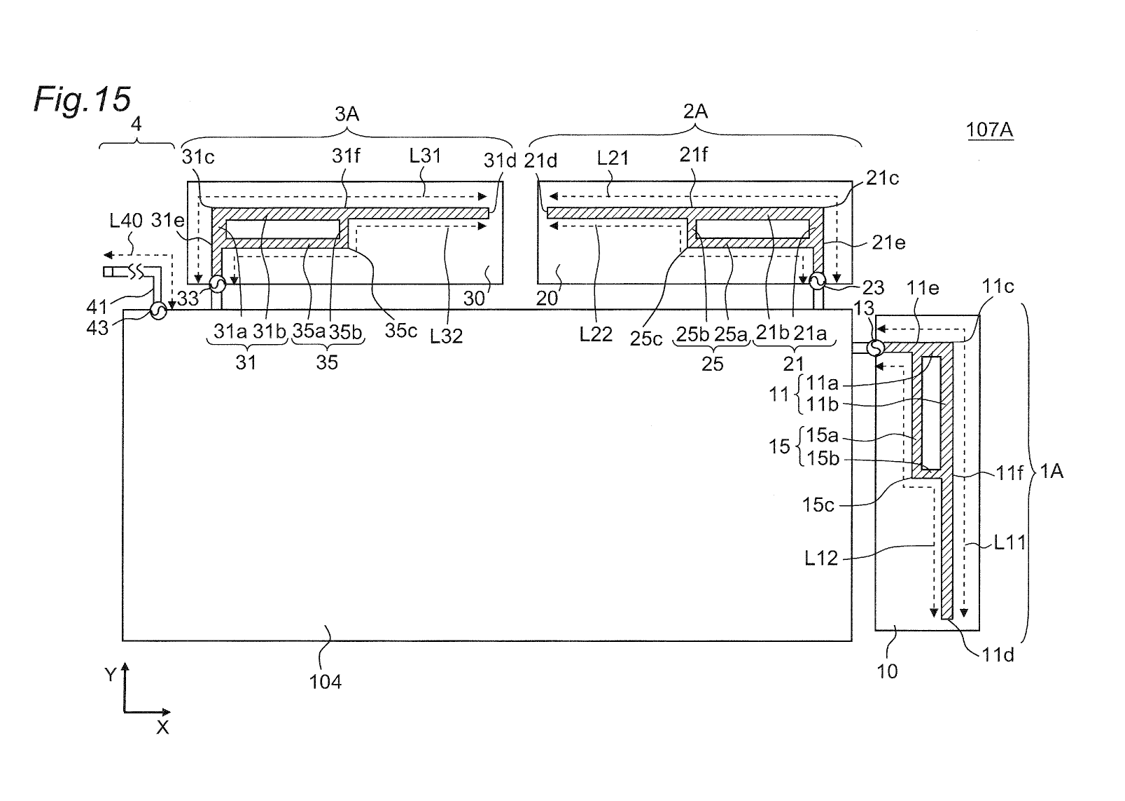

Hereinafter, a second embodiment is described with reference to FIGS. 15 to 19.

[2-1. Configuration]

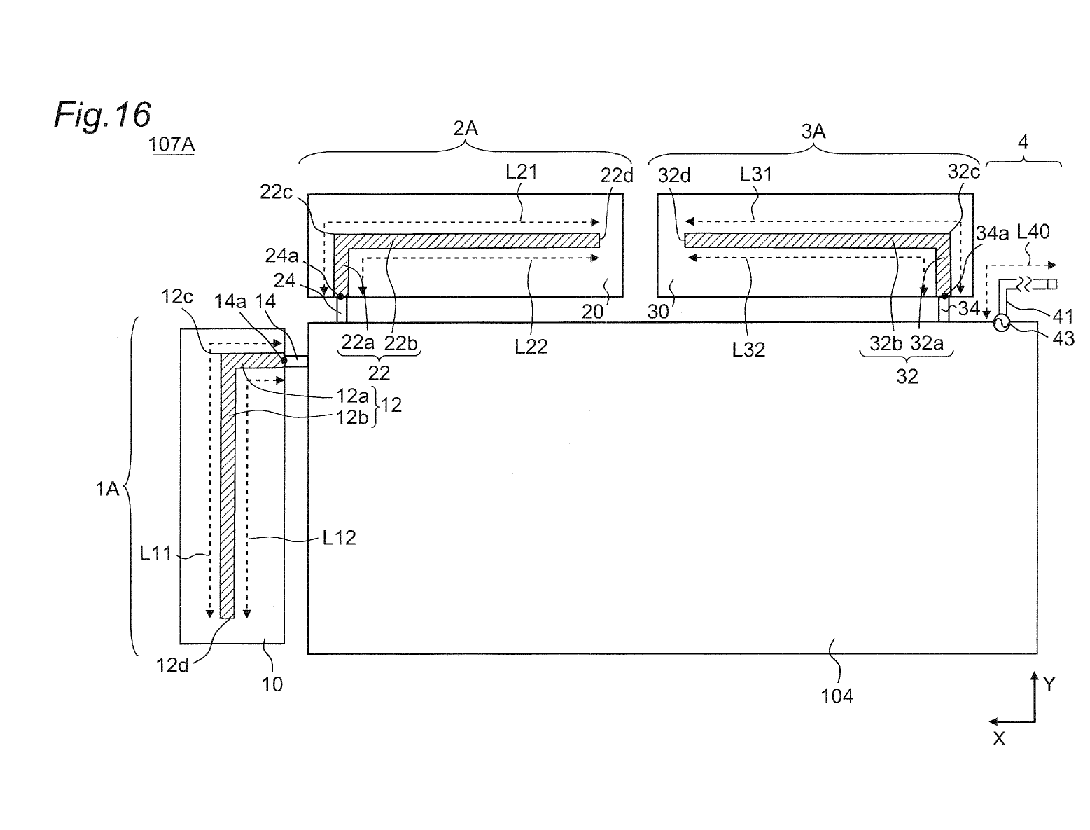

An electronic apparatus 100 of the second embodiment is provided with an antenna apparatus 100A shown in FIGS. 15 and 16, in place of the antenna apparatus 107 of FIG. 1. The antenna apparatus 107A is provided with: antennas 1A, 2A, 3A and 4 formed on dielectric substrates 10, 20, and 30, respectively; and a ground conductor plate 104. λ1 denotes a first wavelength corresponding to a first frequency “f” within an operating band of the electronic apparatus 100, and λ2 denotes a second wavelength corresponding to a second frequency “f” within the operating band. Since the other portions of the electronic apparatus 100 of the second embodiment are configured in the same manner as that of the first embodiment, their explanations are omitted.

FIG. 15 is a plan view of the antenna apparatus 107A according to the second embodiment, seen from a front side thereof. FIG. 16 is a plan view of the antenna apparatus 107A of FIG. 15, seen from a back side thereof.

First, the antenna 1A is explained.

The antenna 1A is provided with a dielectric substrate 10, a feed element (first feed element) 11, and a parasitic element 12, which are similar to those of the antenna 1 of the first embodiment. The antenna 1A is further provided with a second feed element 15 having a strip shape and formed on the front side of the dielectric substrate 10 (FIG. 15). The feed element 15 is made of conductive foil, such as copper or silver. The dielectric substrate 10, the feed elements 11, 15, and the parasitic element 12 are configured as, e.g., a printed-circuit board having conductor layers on both sides.

The feed element 15 has a first end and a second end, the first and second ends being connected to connecting points 11e and 11f at different positions on the feed element 11, respectively. Referring to FIG. 15, the feed element 15 includes element parts 15a and 15b, which are connected to each other at a connecting point 15c. The element part 15a extends substantially toward the −Y direction from an element part 11a of the feed element 11. The element part 15a is connected to the element part 11a of the feed element 11 at the connecting point 11e located at one end of the element part 15a, and connected to the element part 15b at the connecting point 15c of the other end of the element part 15a. The element part 15b extends substantially toward the +X direction from the connecting point 15c. The element part 15b is connected to an element part 11b of the feed element 11 at the connecting point 11f located at one end of the element part 15b, and connected to the element part 15a at the connecting point 15c of the other end of the element part 15b.

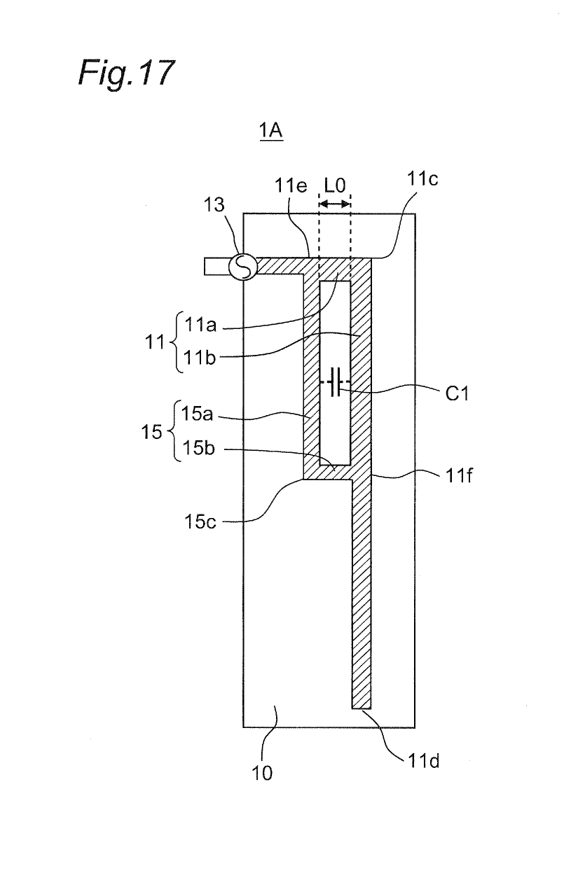

The feed element 15 is arranged to be capacitively coupled to the feed element 11, at at least a portion between the first end (connecting point 11e) and the second end (connecting point 11f) of the feed element 15. FIG. 17 is an enlarged view of the antenna 1A of FIG. 15. The feed elements 11 and 15 are arranged in parallel with a distance L0 (e.g., a distance approximately equal to each width of the feed elements 11 and 15), and therefore, a virtual capacitor C1 appears between them. Since the virtual capacitor C1 is formed between the feed elements 11 and 15, a physical length of the feed elements 11 and 15 is shortened at a frequency determined by a capacitance of the capacitor C1.

When an open end 11d of the feed element 11 and an open end 12d of the parasitic element 12 are capacitively coupled to each other, the antenna 1A operates as a first folded antenna including the feed element 11 and the parasitic element 12, and being folded at the open ends 11d and 12d. An electric length L11 of each of the feed element 11 and the parasitic element 12 capacitively coupled to each other is set to λ1/4, and therefore, an electric length of the first folded antenna is set to λ1/2, and the first folded antenna resonates at the frequency f1. Thus, the feed element 11 and the parasitic element 12 resonate at the first frequency f1 corresponding to the first wavelength determined by the sum of the electric length L11 of the feed element 11 and the electric length L11 of the parasitic element 12.

When the open end 11d of the feed element 11 and the open end 12d of the parasitic element 12 are capacitively coupled to each other, the antenna 1A further operates as a second folded antenna, the second folded antenna including a portion of the feed element 11 from a feeding point 13 to the connecting point 11e, the feed element 15, a portion of the feed element 11 from the connecting point 11f to the open end 11d, and the parasitic element 12, and the second folded antenna being folded at the open ends 11d and 12d. An electric length L12 of the portion of the feed element 11 from the feeding point 13 to the connecting point 11e, the feed element 15, and the portion of the feed element 11 from the connecting point 11f to the open end 11d, when these portions are capacitively coupled to the parasitic element 12, is set to λ2/4. An electric length L12 of the parasitic element 12, when the parasitic element 12 is capacitively coupled to the feed elements 11 and 15, is set to λ2/4. Therefore, an electric length of the second folded antenna is set to λ2/2, and the second folded antenna resonates at a frequency f2. Thus, the feed element 11, the feed element 15, and the parasitic element 12 resonate at the second frequency f2 corresponding to the second wavelength λ2 determined by the sum of the electric length L12 of the feed elements 11 and 15 and the electric length L12 of the parasitic element 12.

The feed element 15 and the parasitic element 12 may be arranged to oppose each other, at at least a portion thereof. In addition, the feed element 15 and the parasitic element 12 may be arranged to be capacitively coupled to each other, at at least a portion thereof. In addition, the feed element 15 and the parasitic element 12 may be arranged to overlap each other, at at least a portion thereof.

Now, the antenna 2A is explained.

The antenna 2A is provided with a dielectric substrate 20, a feed element (first feed element) 21, and a parasitic element 22, which are similar to those of the antenna 2 of the first embodiment. The antenna 2A is further provided with a second feed element 25 having a strip shape and formed on the front side of the dielectric substrate 20 (FIG. 15). The feed element 25 is made of conductive foil, such as copper or silver. The dielectric substrate 20, the feed elements 21, 25, and the parasitic element 22 are configured as, e.g., a printed-circuit board having conductor layers on both sides.

The feed element 25 has a first end and a second end, the first and second ends being connected to connecting points 21e and 21f at different positions on the feed element 21, respectively. Referring to FIG. 15, the feed element 25 includes element parts 25a and 25b, which are connected to each other at a connecting point 25c. The element part 25a extends substantially toward the −X direction from an element part 21a of the feed element 21. The element part 25a is connected to the element part 21a of the feed element 21 at the connecting point 21e located at one end of the element part 25a, and connected to the element part 25b at the connecting point 25c of the other end of the element part 25a. The element part 25b extends substantially toward the +Y direction from the connecting point 25c. The element part 25b is connected to an element part 21b of the feed element 21 at the connecting point 21f located at one end of the element part 25b, and connected to the element part 25a at the connecting point 25c of the other end of the element part 25b.

The feed element 25 is arranged to be capacitively coupled to the feed element 21, at at least a portion between the first end (connecting point 21e) and the second end (connecting point 21f) of the feed element 25. The feed elements 21 and 25 are arranged in parallel with a certain distance (e.g., a distance approximately equal to each width of the feed elements 21 and 25), and therefore, a virtual capacitor appears between them. Since the virtual capacitor is formed between the feed elements 21 and 25, a physical length of the feed elements 21 and 25 is shortened at a frequency determined by a capacitance of the capacitor.

When an open end 21d of the feed element 21 and an open end 22d of the parasitic element 22 are capacitively coupled to each other, the antenna 2A operates as a first folded antenna including the feed element 21 and the parasitic element 22, and being folded at the open ends 21d and 22d. An electric length L21 of each of the feed element 21 and the parasitic element 22 capacitively coupled to each other is set to λ1/4, and therefore, an electric length of the first folded antenna is set to λ1/2, and the first folded antenna resonates at the frequency f1. Thus, the feed element 21 and the parasitic element 22 resonate at the first frequency f1 corresponding to the first wavelength λ1 determined by the sum of the electric length L21 of the feed element 21 and the electric length L21 of the parasitic element 22.

When the open end 21d of the feed element 21 and the open end 22d of the parasitic element 22 are capacitively coupled to each other, the antenna 2A further operates as a second folded antenna, the second folded antenna including a portion of the feed element 21 from a feeding point 23 to the connecting point 21e, the feed element 25, a portion of the feed element 21 from the connecting point 21f to the open end 21d, and the parasitic element 22, and the second folded antenna being folded at the open ends 21d and 22d. An electric length L22 of the portion of the feed element 21 from the feeding point 23 to the connecting point 21e, the feed element 25, and the portion of the feed element 21 from the connecting point 21f to the open end 21d, when these portions are capacitively coupled to the parasitic element 22, is set to λ2/4. An electric length L22 of the parasitic element 22, when the parasitic element 22 is capacitively coupled to the feed elements 21 and 25, is set to λ2/4. Therefore, an electric length of the second folded antenna is set to λ2/2, and the second folded antenna resonates at a frequency f2. Thus, the feed element 21, the feed element 25, and the parasitic element 22 resonate at the second frequency f2 corresponding to the second wavelength λ2 determined by the sum of the electric length L22 of the feed elements 21 and 25 and the electric length L22 of the parasitic element 22.

The feed element 25 and the parasitic element 22 may be arranged to oppose each other, at at least a portion thereof. In addition, the feed element 25 and the parasitic element 22 may be arranged to be capacitively coupled to each other, at at least a portion thereof. In addition, the feed element 25 and the parasitic element 22 may be arranged to overlap each other, at at least a portion thereof.

Now, the antenna 3A is explained.

The antenna 3A is provided with a dielectric substrate 30, a feed element (first feed element) 31, and a parasitic element 32, which are similar to those of the antenna 3 of the first embodiment. The antenna 3A is further provided with a second feed element 35 having a strip shape and formed on the front side of the dielectric substrate 30 (FIG. 15). The feed element 35 is made of conductive foil, such as copper or silver. The dielectric substrate 30, the feed elements 31, 35, and the parasitic element 32 are configured as, e.g., a printed-circuit board having conductor layers on both sides.

The feed element 35 has a first end and a second end, the first and second ends being connected to connecting points 31e and 31f at different positions on the feed element 31, respectively. Referring to FIG. 15, the feed element 35 includes element parts 35a and 35b, which are connected to each other at a connecting point 35c. The element part 35a extends substantially toward the +X direction from an element part 31a of the feed element 31. The element part 35a is connected to the element part 31a of the feed element 31 at the connecting point 31e located at one end of the element part 35a, and connected to the element part 35b at the connecting point 35c of the other end of the element part 35a. The element part 35b extends substantially toward the +Y direction from the connecting point 35c. The element part 35b is connected to an element part 31b of the feed element 31 at the connecting point 31f located at one end of the element part 35b, and connected to the element part 35a at the connecting point 35c of the other end of the element part 35b.

The feed element 35 is arranged to be capacitively coupled to the feed element 31, at at least a portion between the first end (connecting point 31e) and the second end (connecting point 31f) of the feed element 35. The feed elements 31 and 35 are arranged in parallel with a certain distance (e.g., a distance approximately equal to each width of the feed elements 31 and 35), and therefore, a virtual capacitor appears between them. Since the virtual capacitor is formed between the feed elements 31 and 35, a physical length of the feed elements 31 and 35 is shortened at a frequency determined by a capacitance of the capacitor.

When an open end 31d of the feed element 31 and an open end 32d of the parasitic element 32 are capacitively coupled to each other, the antenna 3A operates as a first folded antenna including the feed element 31 and the parasitic element 32, and being folded at the open ends 31d and 32d. An electric length L31 of each of the feed element 31 and the parasitic element 32 capacitively coupled to each other is set to λ1/4, and therefore, an electric length of the first folded antenna is set to λ1/2, and the first folded antenna resonates at the frequency f1. Thus, the feed element 31 and the parasitic element 32 resonate at the first frequency f1 corresponding to the first wavelength λ1 determined by the sum of the electric length L31 of the feed element 31 and the electric length L31 of the parasitic element 32.

When the open end 31d of the feed element 31 and the open end 32d of the parasitic element 32 are capacitively coupled to each other, the antenna 3A further operates as a second folded antenna, the second folded antenna including a portion of the feed element 31 from a feeding point 33 to the connecting point 31e, the feed element 35, a portion of the feed element 31 from the connecting point 31f to the open end 31d, and the parasitic element 32, and the second folded antenna being folded at the open ends 31d and 32d. An electric length L32 of the portion of the feed element 31 from the feeding point 33 to the connecting point 31e, the feed element 35, and the portion of the feed element 31 from the connecting point 31f to the open end 31d, when these portions are capacitively coupled to the parasitic element 32, is set to λ2/4. An electric length L32 of the parasitic element 32, when the parasitic element 32 is capacitively coupled to the feed elements 31 and 35, is set to λ2/4. Therefore, the electric length of the second folded antenna is set to λ2/2, and the second folded antenna resonates at a frequency f2. Thus, the feed element 31, the feed element 35, and the parasitic element 32 resonate at the second frequency f2 corresponding to the second wavelength λ2 determined by the sum of the electric length L32 of the feed elements 31 and 35 and the electric length L32 of the parasitic element 32.

The feed element 35 and the parasitic element 32 may be arranged to oppose each other, at at least a portion thereof. In addition, the feed element 35 and the parasitic element 32 may be arranged to be capacitively coupled to each other, at at least a portion thereof. In addition, the feed element 35 and the parasitic element 32 may be arranged to overlap each other, at at least a portion thereof.

The antenna 4 is configured in a manner similar to that of the antenna 4 of the first embodiment.

The wireless receiving circuit of the main circuit board 103 receives radio signals having the frequencies f1 and f2 using the antennas 1A, 1B, and 1C.

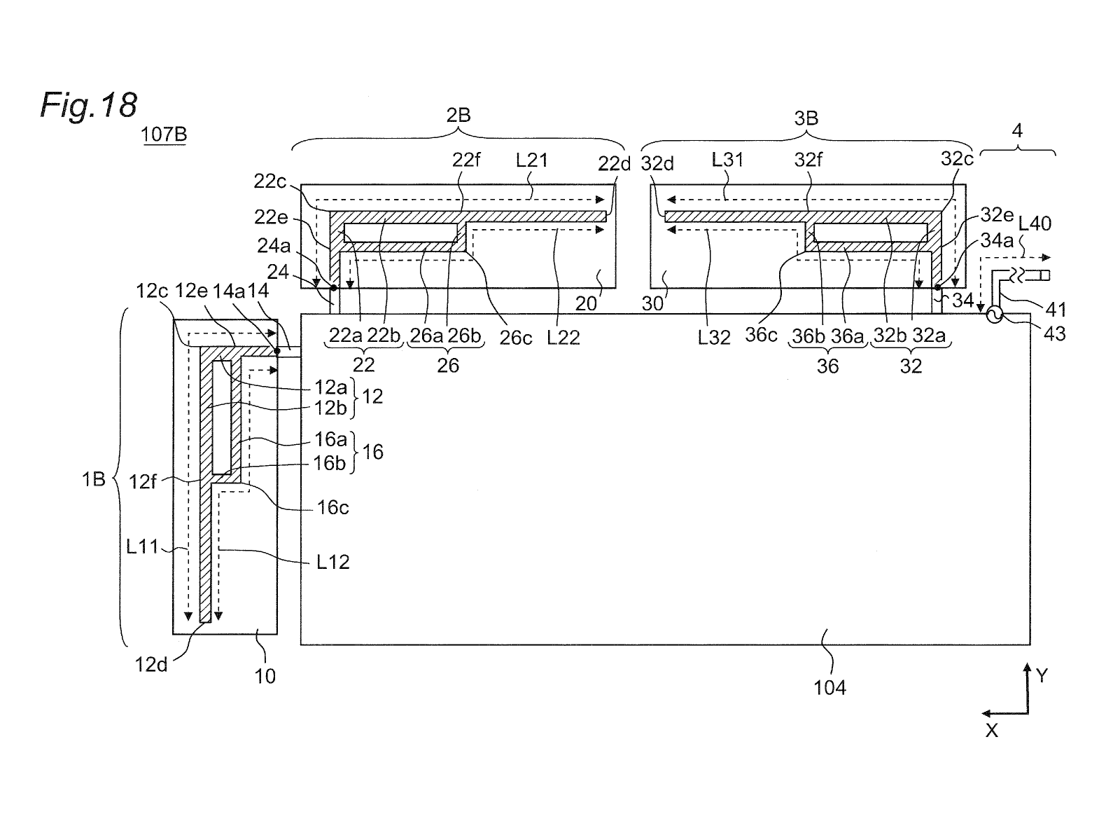

FIG. 18 is a plan view of an antenna apparatus 107B according to a modified embodiment of the second embodiment, seen from a back side thereof.

Referring to FIG. 16, each parasitic element of the antennas 1A, 2A, and 3A has a different shape from that of their feed elements (FIG. 15) (i.e., a shape similar to that of each parasitic element of the antennas 1 to 3 of FIG. 5). However, as shown in FIG. 18, each parasitic element may have a shape similar to that of feed elements (FIG. 15).

The antenna apparatus 107B is provided with: antennas 1B, 2B, 3B, and 4 formed on dielectric substrates 10, 20, and 30, respectively; and a ground conductor plate 104. Front sides of the antennas 1B, 2B, and 3B are configured in a manner similar to those of the antennas 1A, 2A, and 3A of FIG. 15.

First, the antenna 1B is explained.

The antenna 1B is provided with a dielectric substrate 10, feed elements 11, 15, and a parasitic element (first parasitic element) 12, which are similar to those of the antenna 1A of FIGS. 15 and 16. The antenna 1B is further provided with a second parasitic element 16 having a strip shape and formed on the back side of the dielectric substrate 10 (FIG. 18). The parasitic element 16 is made of conductive foil, such as copper or silver. The dielectric substrate 10, the feed elements 11, 15, and the parasitic elements 12, 16 are configured as, e.g., a printed-circuit board having conductor layers on both sides.

The parasitic element 16 has a first end and a second end, the first and second ends being connected to connecting points 12e and 12f at different positions on the parasitic element 12, respectively. Referring to FIG. 18, the parasitic element 16 includes element parts 16a and 16b, which are connected to each other at a connecting point 16c. The element part 16a extends substantially toward the −Y direction from an element part 12a of the parasitic element 12. The element part 16a is connected to the element part 12a of the parasitic element 12 at the connecting point 12e located at one end of the element part 16a, and connected to the element part 16b at the connecting point 16c of the other end of the element part 16a. The element part 16b extends substantially toward the +X direction from the connecting point 16c. The element part 16b is connected to an element part 12b of the parasitic element 12 at the connecting point 12f located at one end of the element part 16b, and connected to the element part 16a at the connecting point 16c of the other end of the element part 16b.

When an open end 11d of the feed element 11 and an open end 12d of the parasitic element 12 are capacitively coupled to each other, the antenna 1B operates as a first folded antenna including the feed element 11 and the parasitic element 12, and being folded at the open ends 11d and 12d. An electric length L11 of each of the feed element 11 and the parasitic element 12 capacitively coupled to each other is set to λ1/4, and therefore, an electric length of the first folded antenna is set to λ1/2, and the first folded antenna resonates at the frequency f1. Thus, the feed element 11 and the parasitic element 12 resonate at the first frequency f1 corresponding to the first wavelength λ1 determined by the sum of the electric length L11 of the feed element 11 and the electric length L11 of the parasitic element 12.

When the open end 11d of the feed element 11 and the open end 12d of the parasitic element 12 are capacitively coupled to each other, the antenna 1B further operates as a second folded antenna, the second folded antenna including a portion of the feed element 11 from a feeding point 13 to the connecting point 11e, the feed element 15, a portion of the feed element 11 from the connecting point 11f to the open end 11d, a portion of the parasitic element 12 from a connecting point 14a to the connecting point 12e, the parasitic element 16, a portion of the parasitic element 12 from the connecting point 12f to the open end 12d, and the second folded antenna being folded at the open ends 11d and 12d. An electric length L12 of the portion of the feed element 11 from the feeding point 13 to the connecting point 11e, the feed element 15, and the portion of the feed element 11 from the connecting point 11f to the open end 11d, when these portions are capacitively coupled to the parasitic elements 12 and 16, is set to λ2/4. An electric length L12 of the portion of the parasitic element 12 from the connecting point 14 to the connecting point 12e, the parasitic element 16, and the portion of the parasitic element 12 from the connecting point 12f to the open end 12d, when these portions are capacitively coupled to the feed elements 11 and 15, is set to λ2/4. Therefore, an electric length of the second folded antenna is set to λ2/2, and the second folded antenna resonates at a frequency f2. Thus, the feed element 11, the feed element 15, the parasitic element 12, and the parasitic element 16 resonate at the second frequency f2 corresponding to the second wavelength λ2/2 determined by the sum of the electric length L12 of the feed elements 11 and 15 and the electric length L12 of the parasitic elements 12 and 16.

The feed elements 11, 15, and the parasitic element 16 may be arranged to oppose each other, at at least a portion thereof. In addition, the feed elements 11,15, and the parasitic element 16 may be arranged to be capacitively coupled to each other, at at least a portion thereof. In addition, the feed elements 11, 15, and the parasitic element 16 may be arranged to overlap each other, at at least a portion thereof.

Now, the antenna 2B is explained.

The antenna 2B is provided with a dielectric substrate 20, feed elements 21, 25, and a parasitic element (first parasitic element) 22, which are similar to those of the antenna 2A of FIGS. 15 and 16. The antenna 2B is further provided with a second parasitic element 26 having a strip shape and formed on the back side of the dielectric substrate 20 (FIG. 18). The parasitic element 26 is made of conductive foil, such as copper or silver. The dielectric substrate 20, the feed elements 21, 25, and the parasitic elements 22, 26 are configured as, e.g., a printed-circuit board having conductor layers on both sides.

The parasitic element 26 has a first end and a second end, the first and second ends being connected to connecting points 22e and 22f at different positions on the parasitic element 22, respectively. Referring to FIG. 18, the parasitic element 26 includes element parts 26a and 26b, which are connected to each other at a connecting point 26c. The element part 26a extends substantially toward the −X direction from an element part 22a of the parasitic element 22. The element part 26a is connected to the element part 22a of the parasitic element 22 at the connecting point 22e located at one end of the element part 26a, and connected to the element part 26b at the connecting point 26c of the other end of the element part 26a. The element part 26b extends substantially toward the +Y direction from the connecting point 26c. The element part 26b is connected to an element part 22b of the parasitic element 22 at the connecting point 22f located at one end of the element part 26b, and connected to the element part 26a at the connecting point 26c of the other end of the element part 26b.

When an open end 21d of the feed element 21 and an open end 22d of the parasitic element 22 are capacitively coupled to each other, the antenna 2B operates as a first folded antenna including the feed element 21 and the parasitic element 22, and being folded at the open ends 21d and 22d. An electric length L21 of each of the feed element 21 and the parasitic element 22 capacitively coupled to each other is set to λ1/4, and therefore, an electric length of the first folded antenna is set to λ1/2, and the first folded antenna resonates at the frequency f1. Thus, the feed element 21 and the parasitic element 22 resonate at the first frequency f1 corresponding to the first wavelength λ1 determined by the sum of the electric length L21 of the feed element 21 and the electric length L21 of the parasitic element 22.

When the open end 21d of the feed element 21 and the open end 22d of the parasitic element 22 are capacitively coupled to each other, the antenna 2B further operates as a second folded antenna, the second folded antenna including a portion of the feed element 21 from a feeding point 23 to the connecting point 21e, the feed element 25, a portion of the feed element 21 from the connecting point 21f to the open end 21d, a portion of the parasitic element 22 from a connecting point 24a to the connecting point 22e, the parasitic element 26, a portion of the parasitic element 22 from the connecting point 22f to the open end 22d, and the second folded antenna being folded at the open ends 21d and 22d. An electric length L22 of the portion of the feed element 21 from the feeding point 23 to the connecting point 21e, the feed element 25, and the portion of the feed element 21 from the connecting point 21f to the open end 21d, when these portions are capacitively coupled to the parasitic elements 22 and 26, is set to λ2/4. An electric length L22 of the portion of the parasitic element 22 from the connecting point 24 to the connecting point 22e, the parasitic element 26, and the portion of the parasitic element 22 from the connecting point 22f to the open end 22d, when these portions are capacitively coupled to the feed elements 21 and 25, is set to λ2/4. Therefore, an electric length of the second folded antenna is set to λ2/2, and the second folded antenna resonates at a frequency f2. Thus, the feed element 21, the feed element 25, the parasitic element 22, and the parasitic element 26 resonate at the second frequency f2 corresponding to the second wavelength λ2 determined by the sum of the electric length L22 of the feed elements 21 and 25 and the electric length L22 of the parasitic elements 22 and 26.

The feed elements 21, 25 and the parasitic elements 22, 26 may be arranged to oppose each other, at at least a portion thereof. In addition, the feed elements 21, 25 and the parasitic elements 22, 26 may be arranged to be capacitively coupled to each other, at at least a portion thereof. In addition, the feed elements 21, 25 and the parasitic elements 22, 26 may be arranged to overlap each other, at at least a portion thereof.

Now, the antenna 3B is explained.

The antenna 3B is provided with a dielectric substrate 30, feed elements 31, 35, and a parasitic element (first parasitic element) 32, which are similar to those of the antenna 3A of FIGS. 15 and 16. The antenna 3B is further provided with a second parasitic element 36 having a strip shape and formed on the back side of the dielectric substrate 30 (FIG. 18). The parasitic element 36 is made of conductive foil, such as copper or silver. The dielectric substrate 30, the feed elements 31, 35, and the parasitic elements 32, 36 are configured as, e.g., a printed-circuit board having conductor layers on both sides.

The parasitic element 36 has a first end and a second end, the first and second ends being connected to connecting points 32e and 32f at different positions on the parasitic element 32, respectively. Referring to FIG. 18, the parasitic element 36 includes element parts 36a and 36b, which are connected to each other at a connecting point 36c. The element part 36a extends substantially toward the +X direction from an element part 32a of the parasitic element 32. The element part 36a is connected to the element part 32a of the parasitic element 32 at the connecting point 32e located at one end of the element part 36a, and connected to the element part 36b at the connecting point 36c of the other end of the element part 36a. The element part 36b extends substantially toward the +Y direction from the connecting point 36c. The element part 36b is connected to an element part 32b of the parasitic element 32 at the connecting point 32f located at one end of the element part 36b, and connected to the element part 36a at the connecting point 36c of the other end of the element part 36b.

When an open end 31d of the feed element 31 and an open end 32d of the parasitic element 32 are capacitively coupled to each other, the antenna 3B operates as a first folded antenna including the feed element 31 and the parasitic element 32, and being folded at the open ends 31d and 32d. An electric length L31 of each of the feed element 31 and the parasitic element 32 capacitively coupled to each other is set to λ1/4, and therefore, an electric length of the first folded antenna is set to λ1/2, and the first folded antenna resonates at the frequency f1. Thus, the feed element 31 and the parasitic element 32 resonate at the first frequency f1 corresponding to the first wavelength λ1 determined by the sum of the electric length L31 of the feed element 31 and the electric length L31 of the parasitic element 32.

When the open end 31d of the feed element 31 and the open end 32d of the parasitic element 32 are capacitively coupled to each other, the antenna 3B further operates as a second folded antenna., the second folded antenna including a portion of the feed element 31 from a feeding point 33 to the connecting point 31e, the feed element 35, a portion of the feed element 31 from the connecting point 31f to the open end 31d, a portion of the parasitic element 32 from a connecting point 34a to the connecting point 32e, the parasitic element 36, a portion of the parasitic element 32 from the connecting point 32f to the open end 32d, and the second folded antenna being folded at the open ends 31d and 32d. An electric length L32 of the portion of the feed element 31 from the feeding point 33 to the connecting point 31e, the feed element 35, and the portion of the feed element 31 from the connecting point 31f to the open end 31d, when these portions are capacitively coupled to the parasitic elements 32 and 36, is set to λ2/4. An electric length L32 of the portion of the parasitic element 32 from the connecting point 34 to the connecting point 32e, the parasitic element 36, and the portion of the parasitic element 32 from the connecting point 32f to the open end 32d, when these portions are capacitively coupled to the feed elements 31 and 35, is set to λ2/4. Therefore, an electric length of the second folded antenna is set to λ2/2, and the second folded antenna resonates at a frequency f2. Thus, the feed element 31, the feed element 35, the parasitic element 32, and the parasitic element 36 resonate at the second frequency f2 corresponding to the second wavelength λ2 determined by the sum of the electric length L32 of the feed elements 31 and 35 and the electric length L32 of the parasitic elements 32 and 36.

The feed elements 31, 35 and the parasitic elements 32, 36 may be arranged to oppose each other, at at least a portion thereof. In addition, the feed elements 31, 35 and the parasitic elements 32, 36 may be arranged to be capacitively coupled to each other, at at least a portion thereof. In addition, the feed elements 31, 35 and the parasitic elements 32, 36 may be arranged to overlap each other, at at least a portion thereof.

[2-2. Operation]

Now, an operation of the antenna apparatus 107A configured as mentioned above is explained.

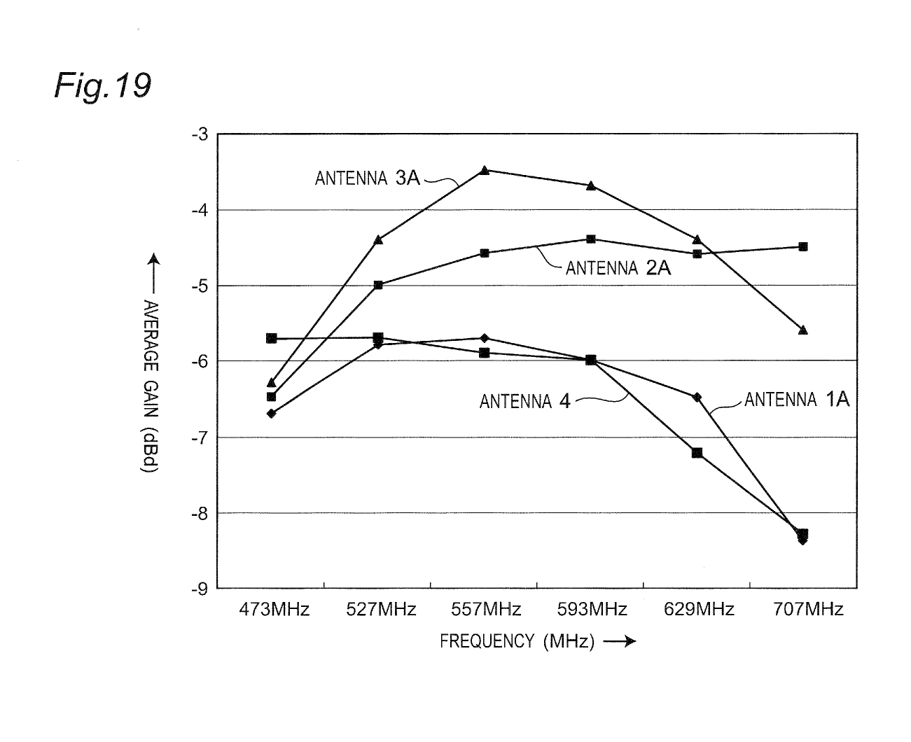

FIG. 19 is a graph showing average gain versus frequency characteristics for the antennas 1A, 2A, 3A, and 4 of FIGS. 15 and 16. The vertical axis of the graph shows an average gain under a cross polarization of −6 dB. As shown in FIG. 19, an average of the average gains of the antennas 1A, 2A, 3A, and 4 was −7.9 dBd or more at respective frequencies of the terrestrial digital television broadcast.

[2-3. Advantageous Effects, etc.]

As described above, the antenna apparatus 107A of the second embodiment is provided with the antennas 1A, 2A, 3A, and 4 and the ground conductor plate 104, and the antennas 1A, 2A, and 3A are configured in a manner similar to those of the antennas 1 to 3 of the antenna apparatus 107 of the first embodiment, and further configured as follows.

The antenna 1A is provided with the feed element 15 having the strip shape and formed on the front side of the dielectric substrate 10. The feed element 15 has the first end and the second end, the first and second ends being connected to the connecting points 11e and 11f at different positions on the feed element 11, respectively. The feed element 11 and the parasitic element 12 are arranged to be capacitively coupled to each other, at at least a portion including the open end 11d of the feed element 11 and the open end 12d of the parasitic element 12. The feed element 11 and the parasitic element 12 resonate at the frequency f1 corresponding to the wavelength λ1 determined by the sum of the electric length L11 of the feed element 11 and the electric length L11 of the parasitic element 12. The feed element 11, the feed element 15, and the parasitic element 12 resonate at the second frequency f2 corresponding to the second wavelength λ2 determined by the sum of the electric length L12 of the feed elements 11 and 15 and the electric length L12 of the parasitic element 12. The feed element 15 is arranged to be capacitively coupled to the feed element 11, at at least a portion between the first end and the second end of the feed element 15.

The antenna 2A is provided with the feed element 25 having the strip shape and formed on the front side of the dielectric substrate 20. The feed element 25 has the first end and the second end, the first and second ends being connected to the connecting points 21e and 21f at different positions on the feed element 21, respectively. The feed element 21 and the parasitic element 22 are arranged to be capacitively coupled to each other, at at least a portion including the open end 21d of the feed element 21 and the open end 22d of the parasitic element 22. The feed element 21 and the parasitic element 22 resonate at the frequency f1 corresponding to the wavelength λ1 determined by the sum of the electric length L21 of the feed element 21 and the electric length L21 of the parasitic element 22. The feed element 21, the feed element 25, and the parasitic element 22 resonate at the second frequency f2 corresponding to the second wavelength λ2 determined by the sum of the electric length L22 of the feed elements 21 and 25 and the electric length L22 of the parasitic element 22. The feed element 25 is arranged to be capacitively coupled to the feed element 21, at at least a portion between the first end and the second end of the feed element 25.

The antenna 3A is provided with the feed element 35 having the strip shape and formed on the front side of the dielectric substrate 30. The feed element 35 has the first end and the second end, the first and second ends being connected to the connecting points 31e and 31f at different positions on the feed element 31, respectively. The feed element 31 and the parasitic element 32 are arranged to be capacitively coupled to each other, at at least a portion including the open end 31d of the feed element 31 and the open end 32d of the parasitic element 32. The feed element 31 and the parasitic element 32 resonate at the frequency f1 corresponding to the wavelength λ1 determined by the sum of the electric length L31 of the feed element 31 and the electric length L31 of the parasitic element 32. The feed element 31, the feed element 35, and the parasitic element 32 resonate at the second frequency f2 corresponding to the second wavelength λ2 determined by the sum of the electric length L32 of the feed elements 31 and 35 and the electric length L32 of the parasitic element 32. The feed element 35 is arranged to be capacitively coupled to the feed element 31, at at least a portion between the first end and the second end of the feed element 35.

Since a virtual capacitor is formed between two feed elements of each antenna, each antenna resonates in a wide band including the frequency f1 and f2. Since the virtual capacitor is formed, it is possible to shorten the physical length of the feed elements at a frequency determined by the capacitance of the capacitor, and reduce the decrease in the gain in higher bands.

The antenna apparatus of the second embodiment further brings about advantageous effects of the antenna apparatus of the first embodiment.

### 3. Other Embodiments

As described above, the first and second embodiments have been explained as exemplary implementations of the present disclosure. However, the embodiment of the present disclosure is not limited thereto, and can be applied to configurations with changes, substitutions, additions, omissions, etc. in an appropriate manner. In addition, the components mentioned in the first and second embodiments can be combined to provide a new embodiment.

Hereinafter, other embodiments are explained collectively.

According to each of the first and second embodiments, the antenna apparatus is provided with three antennas 1 to 3, one monopole antenna, and the ground conductor plate. However, an antenna apparatus may be provided with at least one antenna and the ground conductor plate, the antenna being configured in a manner similar to that of one of the antenna 1 of FIGS. 4 and 5, the antenna 1A of FIGS. 15 and 16, and the antenna 18 of FIG. 18. In addition, the monopole antenna may be omitted, or an antenna apparatus provided with two or more monopole antennas may be provided.

In addition, the ground conductor plate 104 is not limited to be provided as a dedicated component. Other components, such as a shield plate of the electronic apparatus 100, may be used as the ground conductor plate 104 of the antenna apparatus. In addition, the ground conductor plate 104 is not limited to be rectangular, and may be arbitrarily shaped.

In addition, according to the first and second embodiments, the dielectric substrates 10, 20, and 30 are arranged at the chamfered portions of the back cover 105. However, the embodiment of the present disclosure is not restricted thereto. The dielectric substrates 10, 20, and 30 may be arranged on the same surface as that of the ground conductor plate 104, and to be in parallel to the ground conductor plate 104, respectively. The dielectric substrates 10, 20, and 30 may be arranged on a different surface from that of the ground conductor plate 104, and to be in parallel to the ground conductor plate 104, respectively.

In addition, according to the first and second embodiments, the electronic apparatus 100 receives the broadcast signals of the frequency band of the terrestrial digital television broadcast. However, the embodiment of the present disclosure is not restricted thereto. The main circuit board 103 may be provided with a wireless transmitting circuit for transmitting radio signals using the antenna apparatus, and may be provided with a wireless communication circuit for performing at least one of transmission and reception of radio signals using the antenna apparatus. The antenna apparatus provided with the antennas 1 to 4, and the wireless receiving circuit on the main circuit board 103 make up a wireless communication apparatus which performs at least one of transmission and reception of the radio signals. In addition, according to the first and second embodiments, an exemplary electronic apparatus is explained, which is the mobile apparatus for receiving the broadcast signals of the frequency band of the terrestrial digital television broadcast, and displaying their contents. However, the embodiment of the present disclosure is not restricted thereto. The embodiments of the present disclosure are applicable to the antenna apparatus described above, and to the wireless communication apparatus for performing at least one of transmission and reception of radio signals using the antenna apparatus. In addition, the embodiments of the present disclosure are applicable to an electronic apparatus, such as a mobile phone, provided with: the wireless communication apparatus described above, and the display apparatus for displaying the video signals included in the radio signals received by the wireless communication apparatus.

As described above, the applicant presents the embodiments considered to be the best mode, and other embodiments, with reference to the accompanying drawing and detailed description. These are provided to demonstrate the claimed subject matters for those skilled in the art with reference to the specific embodiments. Therefore, the components indicated to the accompanying drawings and the detailed description may include not only components essential for solving the problem, but may include other components. Therefore, even if the accompanying drawings and the detailed description include such non-essential components, it should not be judged that the non-essential components are essential. In addition, various changes, substitutions, additions, omissions, etc. can be done to the above-described embodiments within a range of claims or their equivalency.

The present disclosure is applicable to an electronic apparatus for receiving radio signals, and displaying video signals included in the received radio signals. In particular, the present disclosure is applicable to a portable television broadcast receiving apparatus, a mobile phone, a smart phone, a personal computer, etc.

1-8. (canceled)

9. An antenna apparatus comprising at least one antenna and a ground conductor plate,
wherein each of the at least one antenna comprises:
a dielectric substrate having a first surface and a second surface;
a first feed element having a strip shape and formed on the first surface of the dielectric substrate, the first feed element having a first end connected to a feeding point, and the first feed element having an opened second end; and
a parasitic element having a strip shape and formed on the second surface of the dielectric substrate, the parasitic element having a first end connected to the ground conductor plate, and the parasitic element having an opened second end,
wherein the first feed element and the parasitic element are arranged to oppose each other, at at least a portion including the second end of the first feed element and the second end of the parasitic element, and
wherein each of the at least one antenna further comprises a second feed element having a strip shape and formed on the first surface of the dielectric substrate, the second feed element having a first end and a second end, the first and second ends of the second feed element being connected to different positions on the first feed element, respectively.

10. The antenna apparatus according to claim 9,
wherein the first feed element and the parasitic element are arranged to be capacitively coupled to each other, at at least a portion including the second end of the first feed element and the second end of the parasitic element,
wherein the first feed element and the parasitic element resonate at a first frequency corresponding to a first wavelength determined by a sum of an electric length of the first feed element and an electric length of the parasitic element,
wherein the first feed element, the second feed element, and the parasitic element resonate at a second frequency corresponding to a second wavelength determined by a sum of: an electric length of the first feed element from the first end of the first feed element to a position connected to the second feed element, an electric length of the second feed element, an electric length of the first feed element from the second end of the first feed element to a position connected to the second feed element, and an electric length of the parasitic element, and
wherein the second feed element is arranged to be capacitively coupled to the first feed element, at at least a portion between the first end and the second end of the second feed element.

11. The antenna apparatus of claim 9 comprising: a plurality of feeding points; and a plurality of antennas connected to the plurality of feeding points, respectively.

12. The antenna apparatus according to claim 11, wherein at least one of the plurality of antennas has a different polarization direction from those of the other antennas.

13. The antenna apparatus of claim 9, further comprising at least one monopole antenna.

14. The antenna apparatus according to claim 9, wherein the antenna apparatus is provided in an electronic apparatus comprising a planar conductor component, and wherein the ground conductor plate is the planar conductor component.

15-16. (canceled)

17. A wireless communication apparatus comprising: an antenna apparatus; and a wireless communication circuit configured to perform at least one of transmission and reception of radio signals using the antenna apparatus,
wherein the antenna apparatus comprises at least one antenna and a ground conductor plate,
wherein each of the at least one antenna comprises:
a dielectric substrate having a first surface and a second surface;
a first feed element having a strip shape and formed on the first surface of the dielectric substrate, the first feed element having a first end connected to a feeding point, and the first feed element having an opened second end; and
a parasitic element having a strip shape and formed on the second surface of the dielectric substrate, the parasitic element having a first end connected to the ground conductor plate, and the parasitic element having an opened second end,
wherein the first feed element and the parasitic element are arranged to oppose each other, at at least a portion including the second end of the first feed element and the second end of the parasitic element, and
wherein each of the at least one antenna further comprises a second feed element having a strip shape and formed on the first surface of the dielectric substrate, the second feed element having a first end and a second end, the first and second ends of the second feed element being connected to different positions on the first feed element, respectively.

18. An electronic apparatus comprising a wireless communication apparatus,
wherein the wireless communication apparatus comprises: an antenna apparatus; and a wireless communication circuit configured to perform at least one of transmission and reception of radio signals using the antenna apparatus,
wherein the antenna apparatus comprises at least one antenna and a ground conductor plate,
wherein each of the at least one antenna comprises:
a dielectric substrate having a first surface and a second surface;
a first feed element having a strip shape and formed on the first surface of the dielectric substrate, the first feed element having a first end connected to a feeding point, and the first feed element having an opened second end; and
a parasitic element having a strip shape and formed on the second surface of the dielectric substrate, the parasitic element having a first end connected to the ground conductor plate, and the parasitic element having an opened second end,
wherein the first feed element and the parasitic element are arranged to oppose each other, at at least a portion including the second end of the first feed element and the second end of the parasitic element, and
wherein each of the at least one antenna further comprises a second feed element having a strip shape and formed on the first surface of the dielectric substrate, the second feed element having a first end and a second end, the first and second ends of the second feed element being connected to different positions on the first feed element, respectively.
